(19) United States
(12) Patent Application Publication
(10) Pub. No.: US 2026/0172508 A1
(43) Pub. Date: Jun. 18, 2026

(54) IMAGE FORMING SYSTEM, INFORMATION PROCESSING APPARATUS, AND METHOD OF CONTROLLING THE SAME

(71) Applicant: CANON KABUSHIKI KAISHA, Tokyo (JP)

(72) Inventor: YUKI DAIKU, Chiba (JP)

(21) Appl. No.: 19/409,947

(22) Filed: Dec. 5, 2025

(30) Foreign Application Priority Data
Dec. 13, 2024 (JP) 2024-219007

(51) Int. Cl. H04N 1/00; H04N 1/32

(52) U.S. Cl. CPC H04N 1/00005; H04N 1/00015; H04N 1/00029; H04N 1/00079; H04N 1/00084; H04N 1/00087; H04N 1/32635; H04N 1/32673

(57) ABSTRACT

An image forming system comprising a printing apparatus, an inspection apparatus that inspects a printed material printed by the printing apparatus and an information processing apparatus. The information processing apparatus performs print setting of a job and inspection setting for inspection on the job. The inspection apparatus includes reads a printed material printed in accordance with the job to generate a read image, and detects a precursory phenomenon that can be a defect of the printed material included in the read image. The information processing apparatus predicts whether the defect occurs when printing is performed in accordance with the print setting and the inspection setting, based on the print setting, the inspection setting and the detected precursory phenomenon and notifies in a case where an occurrence of the defect is predicted.

### BACKGROUND

### Field of the Technology

The present disclosure relates to an image forming system, an information processing apparatus, and a method of controlling the same.

### Description of the Related Art

In order to guarantee the quality of a printed material output from a printing apparatus, inspection of the printed material is performed. In recent years, there is a known inspection apparatus that performs inspection by comparing an inspection target image obtained by reading a printed material with a scanner with a reference image in an inspection system that automatically performs inspection. Such an inspection apparatus can detect defects of the printed material such as a spot, streak stain, blank dots, or misalignment of printing positions on the printed material.

These defects may occur by gradual deterioration of a process part inside the apparatus due to long-term use of the printing apparatus or the inspection apparatus. When such deterioration of the part progresses to some extent and a defect that occurs thereby reaches an extent that is not permissible to the user, it is necessary to replace the process part that is a cause of the defect. In this case, for example, a service person is called to repair a defect location. However, in a case of repair that requires a service person, printing cannot be performed while waiting for the arrival of the service person, and thus downtime occurs.

Japanese Patent No. 6972787 discloses a technique of continuing printing while avoiding a fault by adjusting an image forming area and a position of paper so as to move an abnormality such as stain or a fault on the paper to a scheduled cutting area of the paper.

Even if an image defect such as stain occurs on the paper, it is desirable that printing can be continued as long as the degree of the defect is an extent that is permissible to the user. In this case, for example, a job in which a sensitivity (hereinafter, inspection level) for detecting a defect is set to be low may be preferentially executed. However, it is difficult for the user to determine at what extent of inspection level the job can be executed without any problem in the current printing apparatus or the like. As a result, when the job is executed at an inspection level higher than necessary, there are many cases where a failure occurs in the inspection due to the number of times of detection of defects exceeding a threshold, and the job has to be interrupted.

### SUMMARY

Embodiments of the present disclosure eliminate the above-mentioned issues with conventional technology.

A feature of embodiments of the present disclosure is to provide a technique that can suppress occurrence of a situation such as interruption of a job being executed by predicting whether a job will fail in an inspection while the job is being executed before execution of the job.

According to embodiments of the present disclosure, there is provided an image forming system comprising a printing apparatus, an inspection apparatus that inspects a printed material printed by the printing apparatus and an information processing apparatus that controls the printing apparatus and the inspection apparatus, wherein the information processing apparatus includes one or more first controllers including one or more first processors in communication with one or more first memories, the one or more first controllers configured to: perform print setting of a job for causing the printing apparatus to execute printing; and perform inspection setting for inspection in the inspection apparatus on the job, wherein the inspection apparatus includes one or more second controllers including one or more second processors in communication with one or more second memories, the one or more second controllers configured to: read a printed material printed by the printing apparatus in accordance with the job to generate a read image; and detect a precursory phenomenon that can be a defect of the printed material included in the read image, wherein the one or more first controllers further configured to: predict whether the defect occurs when printing is performed in accordance with the print setting and the inspection setting, based on the print setting, the inspection setting and the detected precursory phenomenon; and notify in a case where an occurrence of the defect is predicted, wherein the inspection setting includes an inspection threshold for determining whether the precursory phenomenon corresponds to a defect of the printed material.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the disclosure and, together with the description, serve to explain the principles of the disclosure.

FIG. 1 depicts a view for describing a schematic configuration of an image forming system according to a first embodiment of the present disclosure.

FIG. 2 is a diagram for describing a hardware configuration of the image forming system according to the first embodiment.

FIG. 3 is a functional block diagram for describing a configuration of a software module of the image forming system according to the first embodiment.

FIG. 4 depicts a view illustrating an example of a print setting screen displayed on a display unit of an external PC according to the first embodiment.

FIG. 5 depicts a view illustrating an example of an inspection setting screen displayed on the display unit of the external PC according to the first embodiment.

FIGS. 6A and 6B depict views describing examples of a precursory phenomenon appearing in an inspection target image.

FIGS. 7A and 7B depict views for describing an operation of a precursory phenomenon diagnostic module at the time of tracking a precursory phenomenon in the first embodiment.

FIG. 8 is a graph diagram showing an example of variation of a precursory phenomenon tracked by the precursory phenomenon diagnostic module from precursory phenomenon detection to implementation of automatic recovery.

FIG. 9 depicts a view for describing an operation of an inspection result prediction module according to the first embodiment.

FIG. 10 depicts a view illustrating an example of a warning screen displayed on the display unit when the external PC according to the first embodiment determines that there is a succession of printed materials whose inspection results are NG.

FIGS. 11A and 11B are sequence diagrams for describing from setting of a job to be executed by the image forming system according to the first embodiment to print completion.

FIG. 12 is a flowchart for describing processing of print setting and inspection setting of FIG. 10 to be executed by the external PC in the image forming system according to the first embodiment.

FIGS. 13A and 13B are flowcharts for describing details of precursory phenomenon diagnostic processing (S1109) to be executed by an inspection apparatus of the image forming system according to the first embodiment.

FIG. 14 depicts a view for describing an operation of an inspection result prediction module of an external PC according to a second embodiment.

FIG. 15 is a flowchart for describing processing of print setting and inspection setting (S1101) to be executed by the external PC in an image forming system according to the second embodiment.

FIG. 16 depicts a view illustrating an example of a job management screen that displays a job held in a print job queue in a third embodiment.

FIGS. 17A and 17B are sequence diagrams for describing from setting of a job to be executed by an image forming system according to the third embodiment to print completion.

FIG. 18 depicts a view for describing an operation of an inspection result prediction module according to the third embodiment.

FIG. 19 is a flowchart for describing details of state change processing (S1702) of a job on waiting to be executed by an external PC of the image forming system according to the third embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

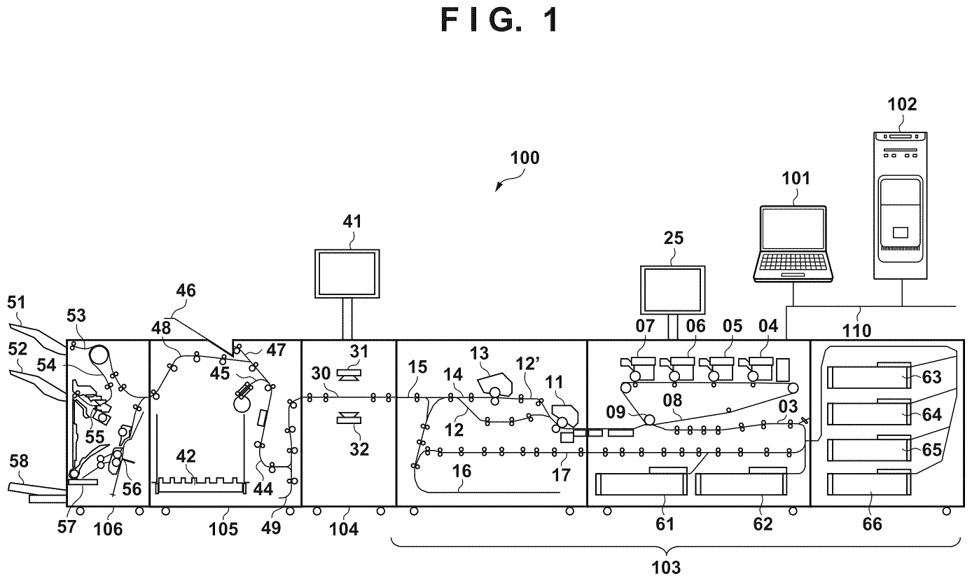

FIG. 1 depicts a view for describing a schematic configuration of an image forming system 100 according to a first embodiment of the present disclosure.

A server 102 generates job data and transmits the generated job data to a printing apparatus 103 and an inspection apparatus 104 to perform printing and inspection. An external PC 101 is connected to the server 102 via a network 110 in a communication-enabling manner. The external PC 101 functions as an information processing apparatus that receives original image data, print setting, and inspection setting by a user operation, and transmits them to the server 102. The server 102 generates, from the received original image data, print image data (hereinafter, simply called image data) necessary for printing and reference image data necessary for inspection. Note that the server 102 may be configured to receive reference image data created in advance from the external PC 101. The server 102 generates job data based on the original image data, various types of setting information, and the reference image data. The external PC 101 instructs the server 102 on job execution in response to an instruction from the user. When the server 102 receives the instruction on job execution, the image data and the print setting information (hereinafter, print job data) of the job data are transmitted to the printing apparatus 103, and the reference image data and the inspection setting information (hereinafter, inspection job data) are transmitted to the inspection apparatus 104. Note that the server 102 may be configured to receive job execution in response to an operation from the user.

The printing apparatus 103 forms (prints) an image on a printing material such as paper or a sheet based on the print job data received from the server 102. A print medium may be long paper. Note that in the first embodiment, a configuration in which the printing apparatus 103 uses an electrophotographic method will be described, but the present disclosure is not limited to this configuration, and for example, a configuration in which the printing apparatus 103 uses another printing method such as an offset printing method or an inkjet method may be adopted. A display unit 25 is a display unit of the printing apparatus 103, the display unit 25 also functioning as an operation panel.

The printing apparatus 103 includes a plurality of paper feed decks. In the embodiment, six types of decks including paper feed decks 61, 62, 63, 64, 65, and 66 are included. Various types of printing materials (paper) are stored in each of the paper feed decks. Among the printing materials stored in each of the paper feed decks, the printing material positioned at the top is separated one by one and fed to a conveyance path 03.

Image forming stations 04 to 07 each include a photosensitive drum (photosensitive element), and each form a toner image on the photosensitive drum using a toner of a different color. Specifically, the image forming stations 04 to 07 form toner images using toners of yellow (Y), magenta (M), cyan (C), and black (K), respectively.

The toner images of the respective colors formed in the image forming stations 04 to 07 are sequentially superimposed and transferred onto an intermediate transfer belt 08 (primary transfer). The toner image transferred to the intermediate transfer belt 08 in this manner is conveyed to a secondary transfer position 09 in accordance with rotation of the intermediate transfer belt 08. At the secondary transfer position 09, the toner image is transferred from the intermediate transfer belt 08 to the printing material conveyed through the conveyance path 03 (secondary transfer). The printing material after the secondary transfer is conveyed to a fixing unit 11. The fixing unit 11 includes a pressing roller and a heating roller. Heat and pressure are applied to the printing material while the printing material passes between these rollers, whereby fixing processing for fixing the toner image on the printing material is performed. The printing material having passed through the fixing unit 11 is conveyed to a connection point 15 between the printing apparatus 103 and the inspection apparatus 104 through a conveyance path 12. In this manner, a color image is formed (printed) on the printing material.

In a case where further fixing processing is required depending on the type of printing material, the printing material having passed through the fixing unit 11 is guided to a fixing unit 13 through a conveyance path 12′. The fixing unit 13 performs further fixing processing on the printing material conveyed through the conveyance path 12′. The printing material having passed through the fixing unit 13 is conveyed to the connection point 15 through a conveyance path 14. In a case where an operation mode for performing double-sided printing is set, an image is printed on a first surface, and the printing material having been conveyed through the conveyance path 12 or the conveyance path 14 is guided to a reverse path 16. The printing material having been reversed in the reverse path 16 is guided to a double-sided conveyance path 17 and conveyed to the secondary transfer position 09. By this, the toner image is transferred to a second surface of the printing material, which is opposite to the first surface, at the secondary transfer position 09. Thereafter, the printing material passes through the fixing unit 11 (and the fixing unit 13), whereby the formation of the color image on the second surface of the printing material is completed.

The image formation (printing) in the printing apparatus 103 is completed, and the printed printing material conveyed to the connection point 15 is conveyed into the inspection apparatus 104.

The inspection apparatus 104 includes image reading units 31 and 32 including contact image sensors (CISs) above and below a conveyance path 30 through which the printed printing material from the printing apparatus 103 is conveyed. The image reading units 31 and 32 are arranged at positions facing each other via the conveyance path 30. The image reading units 31 and 32 are arranged as illustrated in FIG. 1 so as to read the upper (front) surface (first surface) and the lower (back) surface (second surface) of the printing material, respectively. Note that the image reading unit may include, for example, a charge coupled device (CCD) or a line scan camera in place of the CIS. A display unit 41 is a display unit of the inspection apparatus 104, the display unit 41 also functioning as an operation panel.

Based on the image printed on the printed printing material (printed material) to be conveyed through the conveyance path 30, the inspection apparatus 104 performs inspection as to whether the printed material includes a defect and performs precursory phenomenon diagnosis described later. Specifically, the inspection apparatus 104 performs reading processing of reading the image of the printed material using the image reading units 31 and 32 at a timing when the printed material being conveyed reaches a predetermined position. Based on comparison between the read image obtained in this manner and the reference image, precursory phenomenon diagnosis for finding a precursory phenomenon before a defect caused by the printing apparatus 103 occurs, and inspection of a defect of the printed material being printed are performed. Furthermore, the image forming system 100 may be configured to perform image diagnosis for finding a defect that has already occurred. Based on a diagnosis results of these precursory phenomenon diagnosis and image diagnosis, a precursory phenomenon of occurrence of a defect and a cause of the defect are specified, and processing such as automatically restoring or replacing a part (component) that is a cause of the defect is executed.

Note that the precursory phenomenon diagnosis is diagnosis processing in which a precursory phenomenon (fault) in which a defect is expected to occur in the future is found, and even if the precursory phenomenon is found by the precursory phenomenon diagnosis, it is not necessary to immediately restore the precursory phenomenon. The precursory phenomenon diagnosis is basically performed by the user based on an image that is being printed. Note that the fault means a pixel portion in which a difference in pixel value between the inspection target image and the reference image is a predetermined value or more.

A post-processing apparatus 106 applies post-processing on the printed material that is conveyed. Specifically, the post-processing apparatus 106 has post-processing functions such as stapling such as one-point binding or two-point binding, punching such as two holes or three holes, and saddle stitching bookbinding. Note that it is not necessary to have all the functions of stapling, punching, and saddle stitching bookbinding. The post-processing apparatus 106 includes two paper discharge trays 51 and 52, and in a case where post-processing such as stapling is not performed, a sheet bundle is output to the paper discharge tray 51 via a sheet conveyance path 53. On the other hand, in a case where post-processing such as stapling is performed, the designated post-processing is executed by a processing unit 55 via a sheet conveyance path 54 and then the sheet bundle is output to the paper discharge tray 52. The paper discharge trays 51 and 52 can ascend and descend, respectively, and it is possible to operate the paper discharge tray 51 to descend and the printed material subjected to post-processing by the processing unit 55 to be stacked on the paper discharge tray 51. In a case where saddle stitching bookbinding is designated, a saddle stitching processing unit 56 performs stapling processing on the center of the printed material, and then the printed material is folded in two and output to a saddle stitching bookbinding tray 58 via a sheet conveyance path 57. The saddle stitching bookbinding tray 58 has a belt conveyor configuration, and a configuration in which the saddle stitching bookbinding bundle stacked on the saddle stitching bookbinding tray 58 is conveyed to the left side and discharged.

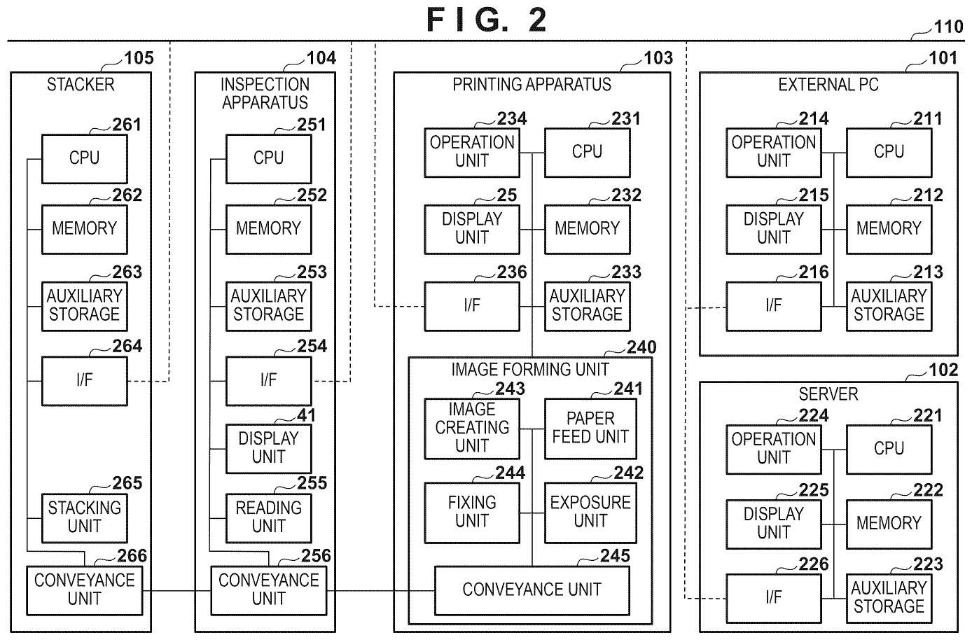

FIG. 2 is a diagram for describing a hardware configuration of the image forming system 100 according to the first embodiment.

First, the configuration of the external PC 101 will be described.

The external PC 101 includes a CPU 211, a memory 212, an auxiliary storage 213, an operation unit 214, a display unit 215, and an interface (I/F) 216. The auxiliary storage 213 stores programs, data, and the like of applications necessary for operating the external PC 101. The CPU 211 deploys, into the memory 212, and executes programs and data stored in the auxiliary storage 213. The operation unit 214 includes a keyboard and a pointing device, and receives input of print setting, inspection setting, and the like from the user. The display unit 215 includes, for example, a liquid crystal display, and displays a screen of an application. Note that the display unit 215 may be a touch panel type in which the operation unit 214 is integrated. The I/F 216 is connected to an I/F 226 of the server 102 via a wired LAN, a wireless LAN, a USB, or the like. The CPU 211 transmits original image data, various types of setting information, and the like to the server 102 through the I/F 216. Information such as a printing status of the printing apparatus 103 and an inspection result of the inspection apparatus 104 is received.

Next, the configuration of the server 102 will be described.

The server 102 includes a CPU 221, a memory 222, an auxiliary storage 223, an operation unit 224, a display unit 225, and an I/F 226. The auxiliary storage 223 stores programs, data, and the like of applications necessary for operating the server 102. The CPU 221 deploys, into the memory 222, and executes programs and data stored in the auxiliary storage 223. The I/F 226 is connected to an I/F of another apparatus through a wired LAN, a wireless LAN, a USB, or the like. The CPU 221 receives original image data, various types of setting information, and the like from the external PC 101 through the I/F 226. Job data is transmitted to the printing apparatus 103 and the inspection apparatus 104 through the I/F 226. Information such as a printing status of the printing apparatus 103 and an inspection result of the inspection apparatus 104 is received through the I/F 226. The CPU 221 stores data received through the I/F 226 into the memory 222 or the auxiliary storage 223. The operation unit 224 includes a keyboard and a pointing device, and receives input of print setting, inspection setting, and the like from the user. The display unit 225 includes, for example, a liquid crystal display, and displays a screen of an application. Note that the display unit 225 may be a touch panel type in which the operation unit 224 is integrated.

Next, the configuration of the printing apparatus 103 will be described.

The printing apparatus 103 includes a CPU 231, a memory 232, an auxiliary storage 233, an operation unit 234, the display unit 25, an I/F 236, and an image forming unit 240. The auxiliary storage 233 stores programs, data, and the like for controlling the printing apparatus 103. The CPU 231 deploys, into the memory 232, and executes programs and data stored in the auxiliary storage 233. The I/F 236 is connected to an I/F 226 of the server 102 via a wired LAN, a wireless LAN, a USB, or the like. The CPU 231 stores print job data received from the server 102 through the I/F 236 into the memory 232 or the auxiliary storage 233. The operation unit 234 includes a keyboard and a pointing device, and receives input for maintaining the printing apparatus 103, for example. The display unit 25 includes, for example, a liquid crystal display, and displays a state of the printing apparatus 103 and the like. The display unit 25 may be a touch panel type operation unit integrated with the operation unit 234.

The image forming unit 240 further includes a paper feed unit 241, an exposure unit 242, an image creating unit 243, a fixing unit 244, and a conveyance unit 245. In the paper feed unit 241, papers are set in advance by the user. Based on the print job data received from the server 102, the image forming unit 240 conveys, along the conveyance unit 245, a paper set in the paper feed unit 241, forms an image on one side or both sides of the paper, and outputs, to the inspection apparatus 104, a printed material on which the image is formed. The exposure unit 242 first charges a photosensitive drum surface to a negative potential. Next, the photosensitive drum is irradiated with a laser beam, and an electrostatic latent image is formed. The image creating unit 243 includes a developing unit, a transfer unit, and a toner replenishment unit, and transfers the toner on the photosensitive drum to the paper. The developing unit adheres the toner negatively charged from a developing cylinder to the electrostatic latent image on the photosensitive drum surface. The transfer unit first charges a primary transfer roller to a positive potential, and transfers the toner on the photosensitive drum surface to the transfer belt. Next, the toner on the transfer belt is transferred to the paper by an outer secondary transfer roller. The fixing unit 244 includes a heating heater, a fixing belt, and a pressure belt, and melts and fixes the toner on the paper to the paper with heat and pressure. The paper feed unit 241 corresponds to the paper feed decks 61, 62, 63, 64, 65, and 66 and the like in FIG. 1. The conveyance unit 245 corresponds to the conveyance paths 03, 12, 14, and 17 and the like, a motor for driving them, and the like. Furthermore, the exposure unit 242, the image creating unit 243, and the fixing unit 244 correspond to the image forming stations 04 to 07, the intermediate transfer belt 08, the fixing units 11 and 13, and the like illustrated in FIG. 1, respectively.

Next, the configuration of the inspection apparatus 104 will be described.

The inspection apparatus 104 includes a CPU 251, a memory 252, an auxiliary storage 253, a conveyance unit 256, a reading unit 255, an I/F 254, and the display unit 41. The auxiliary storage 253 stores programs and data for controlling the inspection apparatus 104. The CPU 251 deploys, into the memory 252, and executes programs and data stored in the auxiliary storage 253. Other than the CPU 251, a GPU not illustrated may be included. The GPU is used to perform image comparison processing at high speed. The I/F 254 is connected to an I/F of the server 102 or the printing apparatus 103 through a wired LAN, a wireless LAN, a USB, the network 110 connecting the printing apparatus 103 and the inspection apparatus 104, or the like.

The CPU 251 stores inspection job data received from the server 102 through the I/F 254 into the memory 252 or the auxiliary storage 253. The CPU 251 is connected also to the operation unit 234 and the display unit 25 of the printing apparatus 103, and the user can perform maintenance and confirmation of the state of the inspection apparatus 104 from the operation unit 234 and the display unit 25 of the printing apparatus 103. The CPU 251 may display the confirmation on the display unit 41 of the inspection apparatus 104.

The reading unit 255 reads one side or both sides of the conveyed printed material using one or more reading sensors (corresponding to the image reading units 31 and 32) provided in the vicinity of the conveyance unit 256 to generate an inspection target image. This reading sensor may be provided only on one side of the printed material, or may be provided on both sides of the front surface side and the back surface side of the printed material to be conveyed, as shown in FIG. 1, in order to simultaneously read both sides of the printed material. In a configuration in which the reading sensor is provided only on one side of the printed material, a front and back of the printed material whose one side has been read may be reversed at the conveyance unit 256, and the reading sensor described above may read the other side. The printed material subjected to the inspection is conveyed to a stacker 105 by the conveyance unit 256. The inspection apparatus 104 compares the inspection target image with the reference image to inspect presence or absence of a defect of the printed material. As a result of the inspection, whether a defect is detected is transmitted to the stacker 105 through the I/F 254.

Next, the configuration of the stacker 105 will be described.

The stacker 105 includes a CPU 261, a memory 262, an auxiliary storage 263, a conveyance unit 266, a stacking unit 265, and an I/F 264. The auxiliary storage 263 stores programs and data for controlling the stacker 105. The CPU 261 deploys, into the memory 262, and executes programs and data stored in the auxiliary storage 263. The I/F 264 is connected to an I/F of the server 102 or the inspection apparatus 104 through a wired LAN, a wireless LAN, a USB, the bus 110 connecting the inspection apparatus 104 and the stacker 105, or the like. The stacking unit 265 includes a stack tray 42 for stacking a printed material determined to be normal by the inspection apparatus 104, and an escape tray 46 for stacking a printed material determined to be a defect. The printed material conveyed by the conveyance unit 266 from the inspection apparatus 104 is stacked on any of the stack tray 42 and the escape tray 46 or sent to the post-processing apparatus 106 via the stacker 105 in accordance with the inspection result of the inspection apparatus 104.

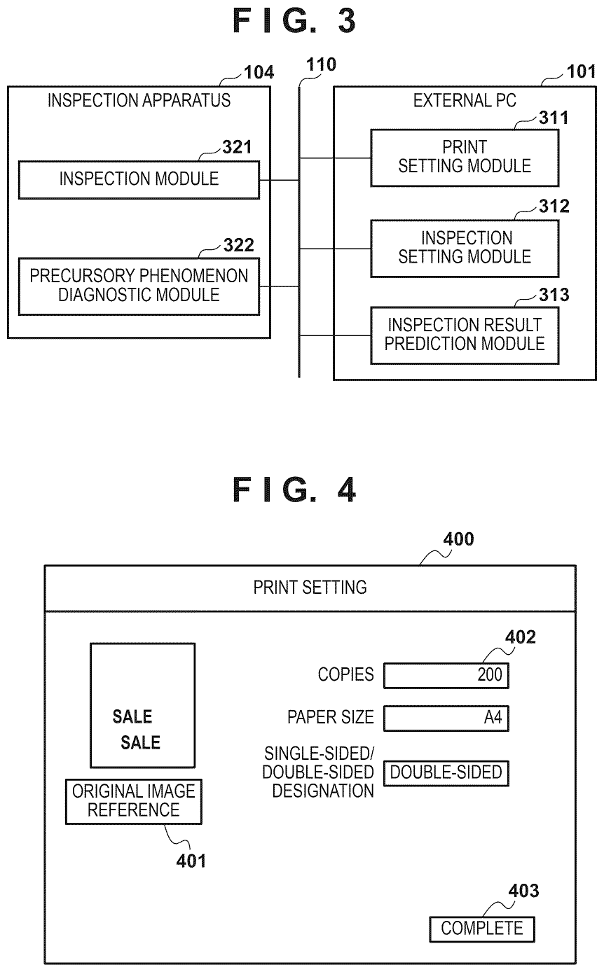

FIG. 3 is a functional block diagram for describing the configuration of a software module of the image forming system 100 according to the first embodiment.

First, functional modules of the external PC 101 will be described.

The external PC 101 includes a print setting module 311, an inspection setting module 312, and an inspection result prediction module 313 as software modules. Note that the functions of these modules are implemented by the CPU 211 of the external PC 101 executing a program deployed in the memory 212.

In the job to be executed, the print setting module 311 performs, based on an operation from the user, print setting such as designation of original image data, print copies, paper size, and single-sided/double-sided printing, color profile, and presence or absence of finishing processing.

FIG. 4 depicts a view illustrating an example of a print setting screen displayed on the display unit 215 of the external PC 101 according to the first embodiment.

A print setting screen 400 is displayed when the user presses a new job creation button on a menu screen (not illustrated) in an application executed by the external PC 101, for example. The print setting screen 400 includes an original image browse button 401, a print copies designation area 402, and a print setting complete button 403. In addition, the print setting screen 400 may include a setting area for performing setting necessary for printing, such as an area for designating a paper size, an area for designating single-sided/double-sided printing, and an area for designating image processing such as color conversion, sharpening, and thin line emphasis.

Here, when the original image browse button 401 is pressed, a file browsing screen on the external PC 101, an external storage not illustrated, or a network server is displayed, and original image data (e.g., PDF file, TIFF file, or the like) can be selected here. In the print copies designation area 402, print copies are set by the user inputting a number. In the other setting areas, setting values are designated in accordance with a user input. When the print setting complete button 403 is pressed, the above settings are confirmed and the screen returns to the previous screen. In place of returning to the previous screen, the screen may transition to an inspection setting screen 500 described later.

In the job to be executed, the inspection setting module 312 performs, based on an operation from the user, inspection settings such as a stain inspection level, a position misalignment inspection threshold, and an inspection area.

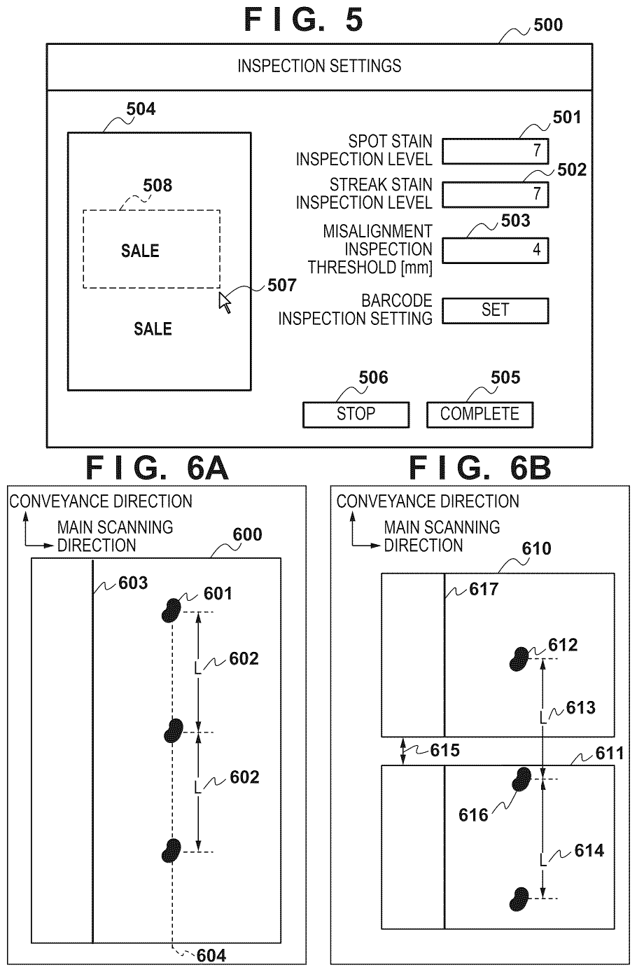

FIG. 5 depicts a view illustrating an example of an inspection setting screen displayed on the display unit 215 of the external PC 101 according to the first embodiment.

This inspection setting screen 500 transitions to be displayed when, for example, a job inspection setting start button (not illustrated) of an application to be executed by the external PC 101 is pressed or when a print setting complete button 403 is pressed on the print setting screen 400 described above.

The inspection setting screen 500 includes an inspection level setting area 501 for spot stain, an inspection level setting area 502 for streak stain, a threshold setting area 503 for position misalignment inspection, an inspection area setting region 504, an inspection setting complete button 505, and an inspection setting stop button 506. In addition, a barcode inspection setting area, a button for reading reference image data created in advance, and a setting area for performing setting necessary for inspection may be included. The inspection level setting area 501 for spot stain and the inspection level setting area 502 for streak stain select the inspection level for detecting spot stains and streak stains, respectively. For example, it is assumed that the level is divided into nine stages from 1 to 9, and the smaller the level number is, the larger the minimum size of detectable stain is, that is, the lower the inspection level is. In FIG. 5, the inspection level of spot stain and the inspection level of streak stain are both set to “7”.

In the threshold setting area 503 for position misalignment inspection, a permissible amount of the size of misalignment when the position where the image is printed is misaligned from an assumed position is input in units of millimeters, for example. In FIG. 5, it is set to 4 mm. In the other setting areas, setting values are designated in accordance with a user input. In the inspection area setting region 504, an area applied with the above setting is designated. For example, when the user performs a drag operation of a cursor 507 by an operation of the pointing device on the image, a rectangular area 508 for which inspection for spot stain is selected. However, not an area for performing inspection but an area (non-inspection area) for not performing inspection may be settable. When the inspection setting stop button 506 is pressed, the inspection setting on this screen is discarded and the screen returns to the previous screen. When the inspection setting complete button 505 is pressed, the setting on this screen is confirmed and the screen returns to the previous screen. Note that in place of returning to the previous screen, the screen may transition to a setting confirmation screen not illustrated. The setting confirmation screen includes an area for displaying the setting value of the print setting described above and the setting value of the inspection setting, and a job start button. When the job start button is pressed, the CPU 211 of the external PC 101 transmits the original image data, the print setting, and the inspection setting to the server 102, and instructs the server 102 on execution start of the job.

The inspection result prediction module 313 determines whether the setting values of the print setting and the inspection setting set by the external PC 101 are setting values with which NG can continuously occur in the inspection apparatus 104 based on precursory phenomenon prediction information generated by a precursory phenomenon diagnostic module 322 of the inspection apparatus 104. Details of the processing performed by the inspection result prediction module 313 will be described later.

Next, functional modules of the inspection apparatus 104 will be described.

The inspection apparatus 104 includes an inspection module 321 and a precursory phenomenon diagnostic module 322 as software modules. Note that the functions of these modules are implemented by the CPU 251 of the inspection apparatus 104 executing a program deployed in the memory 252.

The inspection module 321 detects a defect of the printed material by comparing an inspection target image generated by reading the printed material with a reading sensor (corresponding to the image reading units 31 and 32) with a reference image. The inspection module 321 obtains the inspection setting set by the inspection setting module 312 and the reference image generated by the server 102. An example of spot stain inspection will be described. First, the inspection target image and the reference image are aligned so that the printed patterns match. Next, a difference image is generated by performing difference processing on each image. Next, the difference image is binarized, and a binarized difference image is generated. Next, in a case where the size of a pixel group appearing as a difference in the binarized difference image is larger than a size that can be detected at the inspection level of the spot stain set in the inspection setting module 312, it is determined that a spot stain defect is detected. When the defect is detected, the inspection module 321 notifies the stacker 105 that the defect is detected so that the printed material with the defect is discharged to the escape tray 46 in the stacker 105.

Based on the inspection target image generated by the inspection apparatus 104, the precursory phenomenon diagnostic module 322 detects a precursory phenomenon of occurrence of a defect and performs tracking. This precursory phenomenon includes a small stain (fault) appearing on the printed material when the process part inside the apparatus is gradually damaged or stained due to use of the printing apparatus 103 or the inspection apparatus 104 for a long period of time.

FIGS. 6A and 6B depict views describing examples of a precursory phenomenon appearing in an inspection target image.

Process parts of the printing apparatus that is a cause of a precursory phenomenon include a charge roller, a developer, and a transfer belt. A spot stain and a blank dot on the printed material caused by damage and stain occurring on these parts have a feature of periodically occurring at regular intervals on the image. From such a feature, it is possible to specify the type of a process part that is a cause of the precursory phenomenon. An image 600 in FIG. 6A is an inspection target image, and indicates that a spot stain 601 periodically appears at a same position 604 in a main scanning direction at an interval L 602 in a conveyance direction of the printed material. A luminance change occurring in the inspection target image due to stain of the image reading units 31 and 32 of the inspection apparatus 104 by printed material, toner dust, or the like can also be regarded as a precursory phenomenon. Such a precursory phenomenon has a feature of occurring as a streak shadow on the inspection target image. A streak 603 in FIG. 6A is indicative of continuously appearing in the conveyance direction of the printed material at the same position in the main scanning direction.

The sizes of the various types of precursory phenomena as described above are smaller than a size that can be detected with the inspection level set in the inspection setting. Therefore, as a method of detecting the precursory phenomenon, the precursory phenomenon diagnostic module 322 first detects a fault with a stricter inspection level than the inspection level that can be set in the inspection setting for the inspection target image. Furthermore, it is determined whether the detected fault has a feature specific to the above-described precursory phenomenon. As a determination method, first, pattern matching is performed on a fault appearing at the same position in the main scanning direction, and a plurality of faults having similar shapes at the same main scanning position are extracted. Furthermore, if the plurality of extracted faults periodically appear in the conveyance direction, it is determined that these faults have a feature specific to the precursory phenomenon.

Note that in the print setting screen 400 or the inspection setting screen 500 described above, when the precursory phenomenon is being tracked, an inspection level predicted to result in NG in the inspection may be displayed.

Images 610 and 611 in FIG. 6B are each an inspection target image, and the image 611 illustrates an inspection target image read immediately after the image 610. A streak 617 in FIG. 6B is indicative of continuously appearing in the conveyance direction of the printed materials at the same position in the main scanning direction. In a case where the length of a side parallel to the conveyance direction of the printed material is shorter than twice the period of the precursory phenomenon, it is sometimes not possible to determine whether the precursory phenomenon has periodicity with only one image. For example, a stain 612 on the image 610 is a stain indicating a precursory phenomenon, but it cannot be determined whether the stain has periodicity with the image 610 alone. Therefore, the precursory phenomenon diagnostic module 322 makes a determination using the image 610 and the subsequent image 611. In order to obtain the interval between the faults detected in this manner, an interval 615 between the two images when reading the image 610 and the image 611 that are continuous is obtained from a conveyance speed of the conveyance unit 256 of the inspection apparatus 104 or the like, and is used when obtaining an interval L 613 between the stains 612 and 616. Then, an interval L 614 between the stain 616 and the next stain is obtained, and if the interval L 613 and the interval L 614 are substantially the same, the stain occurs in this period. Alternatively, it may be determined that, without obtaining the period, the precursory phenomenon occurs in a case where an occurrence frequency of the fault appearing at the same position in the main scanning direction is high. In the example of FIG. 6B, the precursory phenomenon is detected from two images, but may be from three or more images. The number of inspection target images to be continuously obtained may be changed based on the period of the process part having the longest operation period and the length in the conveyance direction of the printed material.

Note that as the timing of detecting the precursory phenomenon, detection may be performed at every time the inspection target image is generated, or several inspection target images obtained continuously every predetermined number (e.g., 100) may be targeted. The printed material that is a target of precursory phenomenon diagnosis may be an image that can be an actual product, or a chart for diagnosis may be used.

The precursory phenomenon diagnostic module 322 further tracks the precursory phenomenon having been detected.

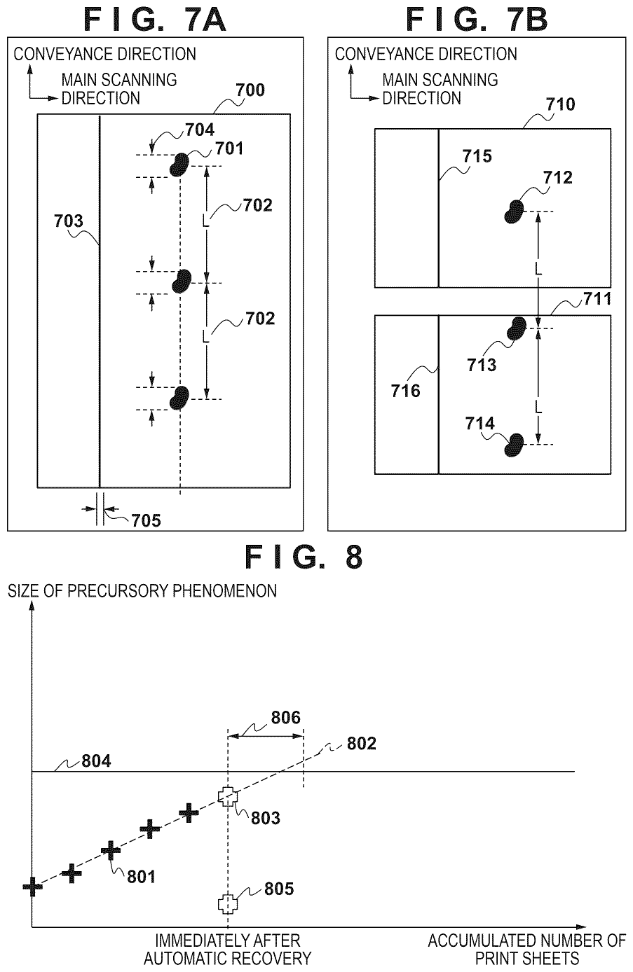

FIGS. 7A and 7B depict views describing the operation of the precursory phenomenon diagnostic module 322 at the time of precursory phenomenon tracking.

An image 700 in FIG. 7A illustrates an example of an inspection target image read by the precursory phenomenon diagnostic module 322 at the time of precursory phenomenon tracking. Images 710 and 711 in FIG. 7B are each an example of an inspection target image read by the precursory phenomenon diagnostic module 322 at the time of precursory phenomenon tracking, and the image 711 is an inspection target image read immediately after the image 710. In the images 710 and 711, streak precursory phenomena 715 and 716 occur. In a case where the precursory phenomenon is a spot stain or a blank dot, as in FIG. 7A, a precursory phenomenon 701 appears at an interval of the operation period L 702 of the process part that is the cause. At the time of precursory phenomenon tracking, the precursory phenomenon is detected in the same manner as at the time of precursory phenomenon detection, and a size 704 of the precursory phenomenon 701 that is detected is recorded. The size of the precursory phenomenon is, for example, a diameter thereof in a case of the spot precursory phenomenon 701. In a case of a streak precursory phenomenon 703, it is a thickness 705 of the streak. In a case where a plurality of precursory phenomena are detected, it is the average of the sizes thereof. As in the images 710 and 711 in FIG. 7B, also in a case where precursory phenomena 712, 713, and 714 are detected over a plurality of images, the average of their sizes is recorded as the size of the precursory phenomenon at the time of tracking. The process part of the cause and the inspection type such as spot or streak are recorded together.

Note that similarly to the detection timing of the precursory phenomenon, as the timing of tracking the precursory phenomenon, tracking may be performed at every time the inspection target image is generated, or may be performed targeting several inspection target images obtained continuously every predetermined number (e.g., 100).

The precursory phenomenon diagnostic module 322 further instructs the printing apparatus 103 on automatic recovery for resolving the precursory phenomenon. Note that this instruction may be instructed by the external PC 101 to the printing apparatus 103 by notifying the external PC 101 of the instruction.

FIG. 8 is a graph diagram showing an example of variation of a precursory phenomenon tracked by the precursory phenomenon diagnostic module 322 from precursory phenomenon detection to implementation of automatic recovery.

FIG. 8 illustrates variation of a precursory phenomenon with one certain process part as a cause, and illustrates an example of variation of a precursory phenomenon of spot stain with, for example, the intermediate transfer belt 08 as a cause. In FIG. 8, a tracking point 801 indicates a size of printing the precursory phenomenon tracked when a predetermined accumulated number of sheets are recorded. The size of the precursory phenomenon occurring in the inspection target image increases in accordance with the accumulated number of print sheets in the image forming system 100. The precursory phenomenon diagnostic module 322 calculates a prediction curve 802 of the size of a future precursory phenomenon based on the size of the precursory phenomenon recorded when the precursory phenomenon is tracked. This prediction curve 802 indicates transition of the size of the precursory phenomenon with respect to the future accumulated number of print sheets, and can be calculated using a known approximation method such as linear regression or polynomial approximation. Then, the precursory phenomenon diagnostic module 322 determines whether the size of the precursory phenomenon indicated by the prediction curve 802 exceeds a size 804 of a precursory phenomenon that can be detected at the inspection level of the immediately preceding job when a predetermined number of sheets 806 are further printed after the job being executed ends. Here, the predetermined number of sheets is the number of sheets printed by the immediately preceding job or a predefined number of sheets. Then, when it is determined that this prediction curve 802 exceeds the size 804 of the precursory phenomenon, the precursory phenomenon diagnostic module 322 causes the printing apparatus 103 to perform automatic recovery. This automatic recovery is processing of automatically resolving the cause of precursory phenomenon. At this time, the precursory phenomenon diagnostic module 322 instructs the process part that is a cause of the precursory phenomenon, for example, the printing apparatus 103, on cleaning of the intermediate transfer belt. For example, the toner stain accumulated on the intermediate transfer belt 08 is removed by operating a transfer belt cleaner for a while.

The precursory phenomenon diagnostic module 322 performs processing equivalent to the tracking of the precursory phenomenon in the first job after causing the printing apparatus 103 to operate the automatic recovery in this manner, and confirms whether the precursory phenomenon has been resolved. In FIG. 8, a precursory phenomenon 805 indicates an example of the size of the precursory phenomenon measured in the first job after the automatic recovery is operated. In the precursory phenomenon 805, since the size of the precursory phenomenon is reduced, it is indicated that the precursory phenomenon has been resolved by the automatic recovery. When the precursory phenomenon is resolved, the tracking point recorded so far is discarded.

On the other hand, a precursory phenomenon 803 indicates an example of the size of the precursory phenomenon when the precursory phenomenon has not been resolved by the automatic recovery. As an example in which the precursory phenomenon is not improved, deterioration of a process part that is difficult to clean, such as a charge roller and pre-exposure, is considered. In a case where a damage occurring in the part worsens, it is not possible to improve even by automatic recovery. In a case where the precursory phenomenon has not been resolved in this manner, the precursory phenomenon diagnostic module 322 stops the job about to be executed. Then, at the same time as stopping the job, the display unit 215 of the external PC 101 may display a message recommending a request for repair or part replacement by the service person. Alternatively, the image forming system 100 needs to notify the service person via the Internet to repair or replace the problematic part. The precursory phenomenon diagnostic module 322 confirms whether the precursory phenomenon has been resolved after repair or replacement of the part by the service person is performed. In a case where the precursory phenomenon is resolved in this manner, the tracking point recorded so far is discarded.

The inspection result prediction module 313 is executed on an application necessary for operating the system in the external PC 101. When performing the print setting or the inspection setting of the job, the inspection result prediction module 313 determines whether the size of any precursory phenomenon reaches the size that can be detected at the inspection level of the inspection setting during the execution of the job. Methods of this determination include a method of determining based on the print setting or the inspection setting of the job and a tracking record of the precursory phenomenon generated in the precursory phenomenon diagnostic module 322.

The inspection result prediction module 313 obtains the print setting and the inspection setting set in the print setting module 311 and the inspection setting module 312, respectively. Furthermore, the tracking record of the precursory phenomenon generated in the precursory phenomenon diagnostic module 322 is obtained.

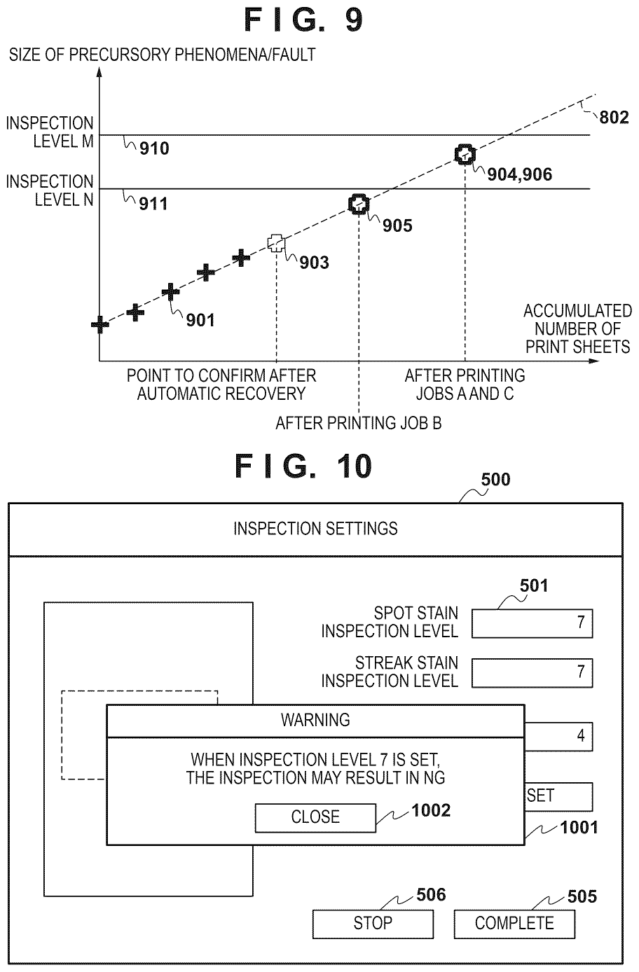

FIG. 9 depicts a view for describing the operation of the inspection result prediction module 313 according to the first embodiment.

In FIG. 9, a tracking point 901 indicates an example of variation of a precursory phenomenon with one certain process part as a cause, and indicates an example of variation of a precursory phenomenon of spot stain with, for example, the intermediate transfer belt 08 as a cause. In FIG. 9, the sizes of the precursory phenomenon designated by reference numerals 910 and 911 indicate minimum sizes that can be detected at an inspection level M and an inspection level N, respectively. Here, it is illustrated that the inspection level N can detect a smaller defect than the inspection level M.

The tracking point 901 indicates the size of the precursory phenomenon when tracking is performed in the precursory phenomenon diagnostic module 322. Similarly to FIG. 8, a dashed line 802 is a prediction curve calculated from the tracking point 901 in the precursory phenomenon diagnostic module 322. A precursory phenomenon 903 after automatic recovery indicates the size of the precursory phenomenon after the automatic recovery is performed, and here, it indicates that the precursory phenomenon has not been resolved by the automatic recovery. A precursory phenomenon 904 after printing by a job A and a precursory phenomenon 905 after printing by a job B indicate prediction values of the size of the precursory phenomena in a case of assuming that printing is performed for only print copies set in the job A and the job B for which different numbers of copies are set. It is indicated that the number of print sheets of the job A is larger than that of the job B, and the size of the predicted fault is also larger. A precursory phenomenon 906 after printing by a job C indicates a prediction value of the size of a fault in a case of performing printing of the job C in which the same number of copies as that of the job A is set, and the same size as that of the job A is predicted. Here, it is assumed that an inspection setting different from that of the job A is performed in the job C.

The inspection result prediction module 313 calculates the number of print sheets to be printed by print completion from the number of print sheets and the number of pages of the original image data set in the print setting. Then, the size of the fault when the number of sheets is printed is predicted based on the prediction curve 802. Furthermore, the inspection result prediction module 313 determines whether the predicted size of the fault exceeds the detection size of the inspection level set in the inspection setting. In FIG. 9, the precursory phenomenon 904 after printing by the job A exceeds the detectable size 911 of the inspection level N. Then, when the inspection level N is set for the job A, the inspection result prediction module 313 determines that the printed material in which the size of the fault exceeds the detectable size 911 of the inspection level N during the execution of the job and the inspection result is NG is continuously generated.

In FIG. 9, the precursory phenomenon 905 after printing by the job B is smaller than the detectable size 911 of the inspection level N. Therefore, when the inspection level N is set for the job B, the inspection result prediction module 313 determines that the size of the defect does not exceed the detectable size 911 of the inspection level N during the execution of the job. By this, when the inspection level N is set for the job B, it is determined that printed material whose inspection result is NG is not continuously generated.

In FIG. 9, the precursory phenomenon 906 after printing by the job C is smaller than the detectable size 910 of the inspection level M. Then, when the inspection level M is set for the job C, the inspection result prediction module 313 determines that the size of the fault does not exceed the detectable size 910 of the inspection level M during the execution of the job. By this, when the inspection level M is set for the job C, it is determined that the printed material whose inspection result is NG is not continuously generated while the job C is being executed.

In this manner, the inspection result prediction module 313 warns the user in a case of determining that the printed material whose inspection result is NG is continuously generated during the execution of the job.

FIG. 10 depicts a view illustrating an example of a warning screen to be displayed on the display unit 215 when the external PC 101 according to the first embodiment determines that printed material whose inspection result is NG is continuously generated. FIG. 10 illustrates a state in which a warning is displayed as a popup on the inspection setting screen 500 in FIG. 5.

This warning is displayed as a popup 1001 in a case where the inspection result prediction module 313 determines that an inspection setting will result in a succession of printed material whose inspection result is NG when the print setting or the inspection setting is performed by the user. On the inspection setting screen 500, since the inspection setting is performed for each inspection type such as the inspection level of spot stain and the inspection level of streak stain, the inspection result prediction module 313 determines whether to display a popup for each inspection type. In the example of FIG. 10, the inspection level of the spot stain and the inspection level of the streak stain are both set to 7, and it is displayed to notify the user that inspection NG may occur with the setting of the inspection level 7.

Specifically, for the job A in FIG. 9, the warning is displayed at the timing when the inspection level N is selected in the spot stain inspection level setting area 501 of the inspection setting screen 500. This timing may be a timing when the inspection setting complete button 505 is pressed. In a case of a method of setting in which options of setting values are displayed by pull-down or the like and a setting value clicked by the pointing device is acquired, the option for which a warning is to be given may be displayed in a visually recognizable manner such as being grayed out. In this case, a warning may be displayed as a popup when the grayed out option is clicked. This warning displays a message notifying the user that inspection NG may occur. This message is provided with a close button 1002, and when the close button 1002 is pressed, the screen returns to the inspection setting screen 500.

This enables the user to stop the execution of the job or change and execute the inspection setting after knowing whether inspection NG may occur. Note that in a case of displaying a warning before executing automatic recovery for the precursory phenomenon being tracked, the user may be urged to execute automatic recovery. For example, a message prompting automatic recovery may be displayed on the popup 1001, or a button for executing automatic recovery may be provided. This warning is not limited to popup display, and may be, for example, light, sound, voice, or the like.

In FIG. 10, the message displayed in the popup 1001 is “Inspection NG may occur in setting of inspection level 7”, but the message may be changed depending on the inspection level. For example, “Printing is impossible” may be displayed when the inspection level is high, and “Inspection NG is highly likely to occur when the number of print sheets is large” may be displayed when the inspection level is low.

The inspection result prediction module 313 does not display the popup 1001 in a case where the setting is not such that it is determined that a succession of printed material whose inspection result is NG will be generated. Specifically, in the example of FIG. 9, when the inspection level M is set for the job C, the warning is not displayed.

This can prevent the occurrence of a situation in which the job is interrupted and rework occurs due to continuous NG. Furthermore, by preferentially performing a job with a smaller number of print sheets or a job with a looser inspection level, printing can be continued also while waiting for the arrival of the service person.

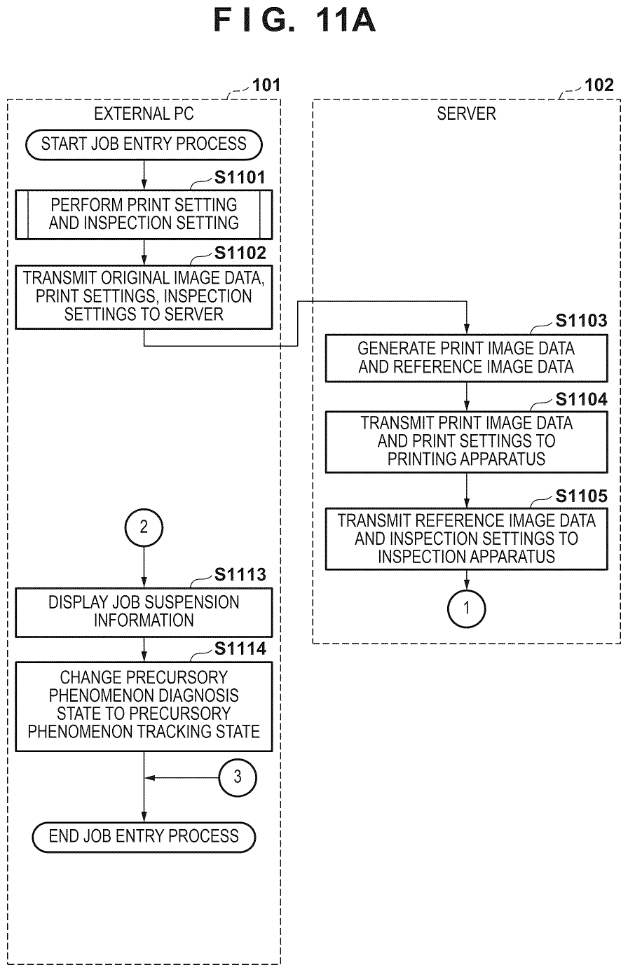

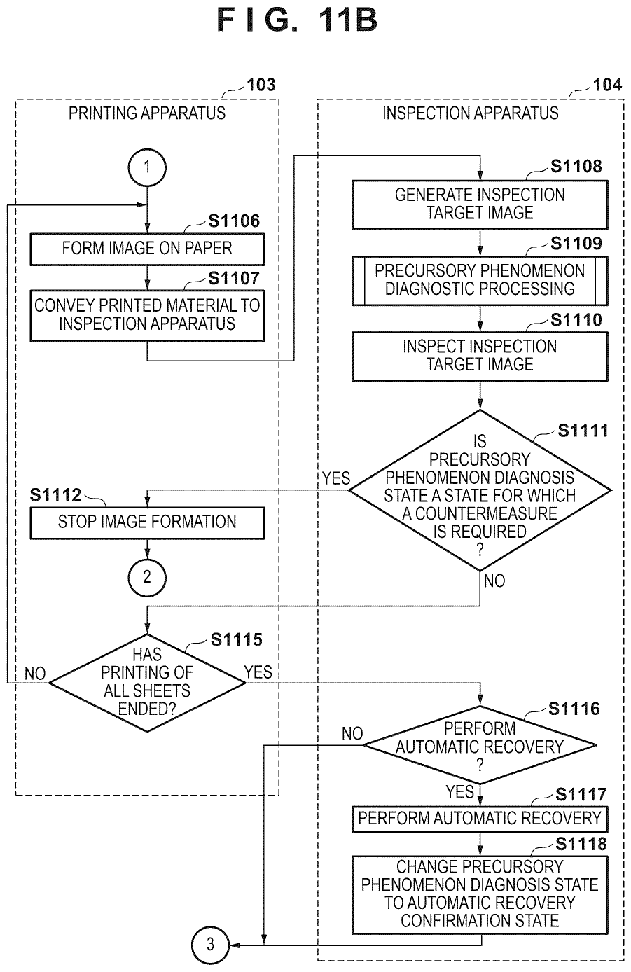

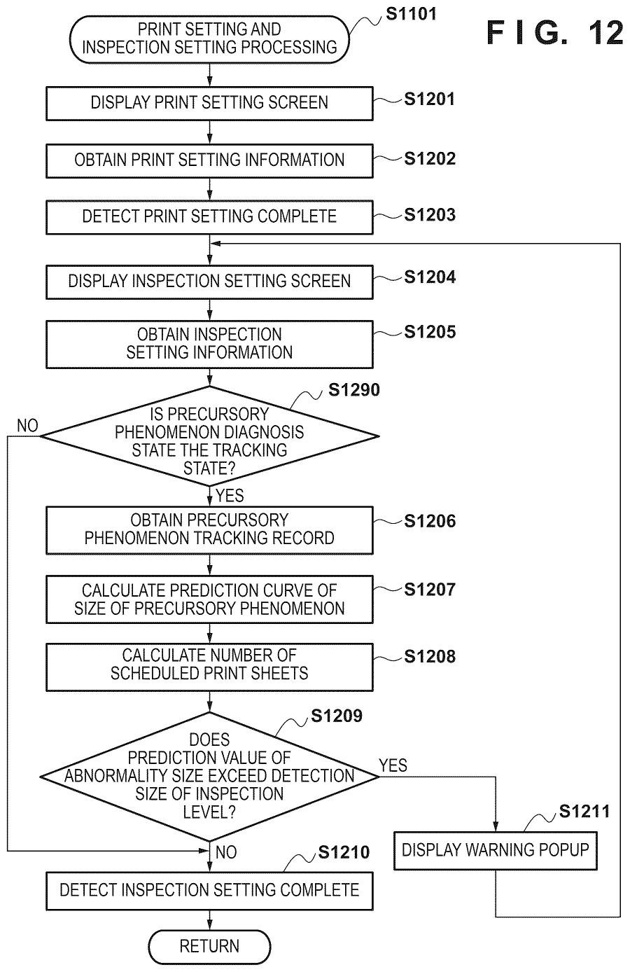

FIGS. 11A and 11B are sequence diagrams for describing from setting of a job to be executed by the image forming system 100 according to the first embodiment to print completion. This sequence is started when a program of an application necessary for operating the system is activated in the external PC 101.

First, in step S1101, the CPU 211 of the external PC 101 performs print setting and inspection setting. Details of this processing will be described later with reference to FIG. 12. Next, the process proceeds to step S1102, when the CPU 211 transmits the original image data, the print setting, and the inspection setting to the server 102 and instructs the server 102 on execution start of the job, the process proceeds to step S1103, which is processing by the server 102.

In step S1103, the CPU 221 of the server 102 generates image data and reference image data. Here, the reference image data includes an RIP image in which the original image data is converted into a raster image, and an attribute image having inspection area information set in the inspection area setting region of the inspection setting. Note that the reference image data created in advance may be received from the external PC 101. In place of the RIP image, original image data may be printed, and a scanned image in which the original image data is scanned may be used as the reference image data. For example, a scanned image created by printing a plurality of sheets of original image data and combining read images read by the reading unit can be used as the reference image data. The image data is image data in which image processing designated in the print setting by the user, such as color conversion, sharpening, and thin line emphasis, is further performed on the RIP image. When the generation of the image data and the reference image data is completed in this manner, the process proceeds to step S1104.

In step S1104, the CPU 221 of the server 102 starts execution of the job. When the execution of the job is started, the image data and the print setting information of the job data are transmitted to the printing apparatus 103. Next, the process proceeds to step S1105, the CPU 221 of the server 102 transmits the reference image data and the inspection setting information to the inspection apparatus 104. When the transmission is completed in this manner, the process proceeds to the processing of the printing apparatus 103 in step S1106.

In step S1106, the CPU 231 of the printing apparatus 103 forms an image on paper. Next, the process proceeds to step S1107, and the CPU 231 conveys the printed material to the inspection apparatus 104.

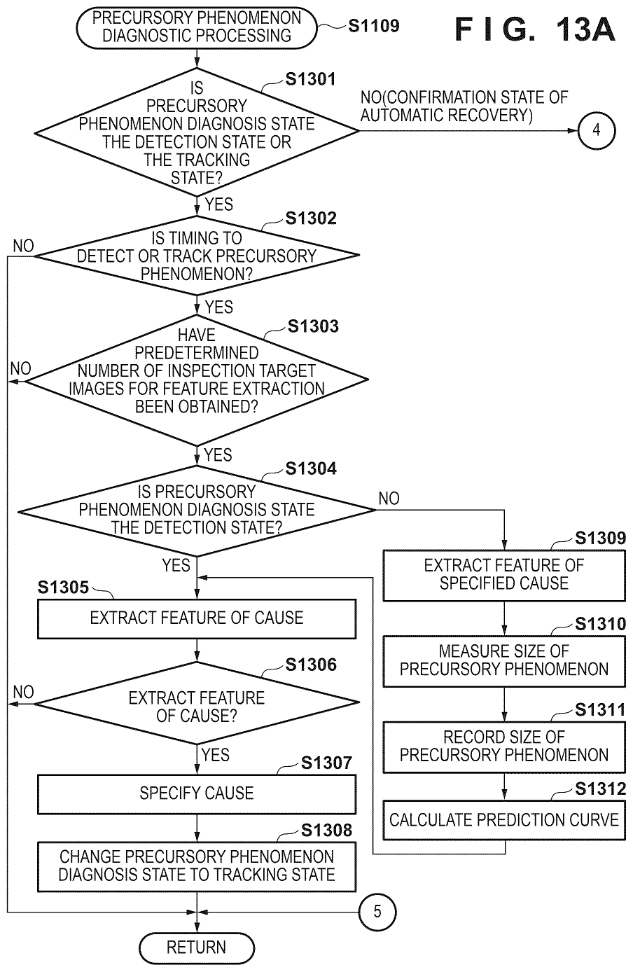

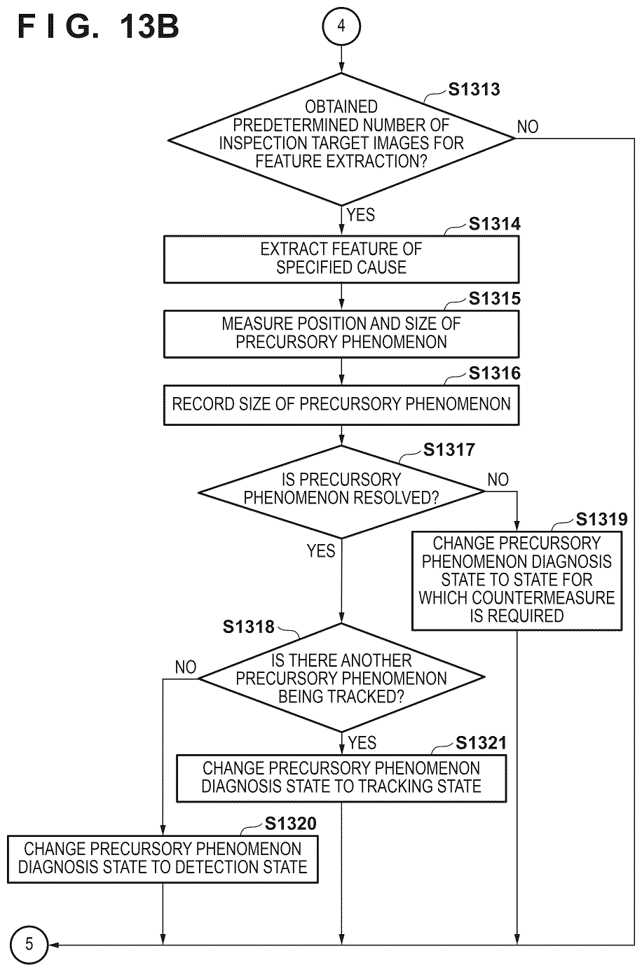

Next, the process proceeds to step S1108, and the CPU 251 of the inspection apparatus 104 reads, by the reading unit 255, the printed material conveyed from the printing apparatus 103 to generate an inspection target image (scanned image). Next, the process proceeds to step S1109, and the CPU 251 of the inspection apparatus 104 performs precursory phenomenon diagnosis based on the inspection target image. This will be described later in detail with reference to FIGS. 13A and 13B.

Next, the process proceeds to step S1110, and the CPU 251 of the inspection apparatus 104 inspects the inspection target image. Then, the process proceeds to step S1111, and the CPU 251 determines whether the precursory phenomenon diagnosis state is a state for which a countermeasure is required. The precursory phenomenon diagnosis state is an initial stage when this image forming system 100 is started to be used, and a precursory phenomenon detection state is initialized when the precursory phenomenon has not been detected yet. In the flow details of the precursory phenomenon diagnosis described later, when the precursory phenomenon is not resolved by the automatic recovery, the precursory phenomenon diagnosis state is switched to the state for which a countermeasure is required. If the CPU 251 determines in step S1111 that the precursory phenomenon diagnosis state is the state for which a countermeasure is required, the process proceeds to step S1112 in order to stop the job or notify the service person. In step S1112, the CPU 231 of the printing apparatus 103 stops image formation and notifies the external PC 101 that the job has been stopped.

By this, in step S1113, the CPU 211 of the external PC 101 displays that the job has been stopped on the display unit 215 of the external PC 101. At this time, a message recommending a request to the service person for repair or part replacement may be simultaneously displayed, or the image forming system 100 needs notify the service person via the Internet. Thereafter, the process proceeds to step S1114, the CPU 211 of the external PC 101 changes the precursory phenomenon diagnosis state to a precursory phenomenon tracking state, and the job input processing ends.

On the other hand, in a case where the CPU 251 of the inspection apparatus 104 determines in step S1111 that the precursory phenomenon diagnosis state is not the state for which a countermeasure is required, it is determined that the printing can be continued, and the process proceeds to step S1115. In step S1115, the CPU 231 of the printing apparatus 103 determines whether printing of all the copies designated in the job has ended, and when determining that printing has not ended, the process proceeds to step S1106, and image formation of the next page or the first page of the next copy is started. When the CPU 231 determines in step S1115 that printing of all the copies has ended, the process proceeds to step S1116.

In step S1116, the CPU 251 of the inspection apparatus 104 determines whether to perform automatic recovery. In step S1116, it is determined whether the prediction curve at the time of further printing, from the current state, by the number of sheets printed by the job for which printing has ended exceeds the detectable size of the inspection level of the immediately preceding job. In a case where it is determined in step S1116 that it exceeds and the precursory phenomenon diagnosis state is the precursory phenomenon tracking state, the process proceeds to step S1117, and the CPU 251 causes the printing apparatus 103 to perform automatic recovery and the process proceeds to step S1118. Otherwise, this job input processing ends. After the printing apparatus 101 performs the automatic recovery, the CPU 251 of the inspection apparatus 104 changes in step S1118 the precursory phenomenon diagnosis state to an automatic recovery confirmation state, and ends this processing. With the state being changed to the automatic recovery confirmation state in this manner, when the next job is input, processing of confirming whether the size of the precursory phenomenon has been improved in the detailed flow of the precursory phenomenon diagnosis described later is performed.

By the processing described above, in a case where the inspection target image obtained by reading the printed material includes a precursory phenomenon (fault), the precursory phenomenon before a defect caused by the printing apparatus occurs in the future is found based on the feature of the cause of the precursory phenomenon. In this manner, it is possible to specify a precursory phenomenon of occurrence of a defect caused by the printing apparatus and a cause of the defect, and automatically execute processing such as repairing or replacing a part that is the cause of the defect.

FIG. 12 is a flowchart for describing the processing of the print setting and the inspection setting (S1101) to be executed by the external PC 101 in the image forming system 100 according to the first embodiment. Note that the processing described in this flowchart is implemented by the CPU 211 of the external PC 101 executing a program deployed in the memory 212. The processing described in this flowchart is started by pressing the new job creation button not illustrated in an application executed by the external PC 101, for example.

First, in step S1201, the CPU 211 displays the print setting screen 400 illustrated in FIG. 4 described above, for example, on the display unit 215 of the external PC 101. Next, the process proceeds to step S1202, and the CPU 211 obtains the print setting information designated by the user operating the print setting screen 400. Next, the process proceeds to step S1203, and the CPU 211 detects that the print setting has been completed by the user pressing the print setting complete button 403.

Next, the process proceeds to step S1204, and the CPU 211 displays the inspection setting screen 500 illustrated in FIG. 5, for example, on the display unit 215 of the external PC 101. Next, the process proceeds to step S1205, and the CPU 211 obtains the inspection setting information designated by the user operating the inspection setting screen 500. For example, when the level is designated in the spot stain inspection level setting area, the level is obtained. Then, the process proceeds to step S1290, and the CPU 211 determines whether the precursory phenomenon diagnosis state is the tracking state. When the tracking state is determined, the process proceeds to step S1206, and the CPU 211 functions as the inspection result prediction module 313 to start inspection result prediction. In a case of not the tracking state, that is, a detection state of detecting the precursory phenomenon or a confirmation state of automatic recovery, the process proceeds to step S1210. The reason why the inspection result prediction is not performed in the confirmation state of automatic recovery is that it is necessary to execute a job in order to confirm whether the precursory phenomenon has been resolved by the automatic recovery. In step S1210, the CPU 211 waits for the user to press the inspection setting complete button 505. When it is detected that the inspection setting complete button 505 is pressed, the inspection setting is confirmed, and this print setting and the inspection setting processing are ended.

In step S1206, the CPU 211 obtains a tracking record of the precursory phenomenon. Next, the process proceeds to step S1207, and the CPU 211 calculates a prediction curve of the size of the precursory phenomenon from the acquired tracking record of the precursory phenomenon. Then, the process proceeds to step S1208, and the CPU 211 calculates the number of scheduled print sheets to be printed up until print completion from the number of print copies and the number of pages of the original image data set in the print setting. Then, the process proceeds to step S1209, and the CPU 211 determines whether or not the prediction value of the size of the precursory phenomenon at the time of print completion exceeds the detection size of the inspection level set in the inspection setting, using the obtained number of scheduled print sheets and the prediction curve. Here, if it is determined that the prediction value exceeds the detection size, the process proceeds to step S1211, and the CPU 211 displays the popup 1001 of warning on the display unit 215. When it is detected that the close button 1002 of the popup 1001 of this warning is pressed by the user, the process proceeds to step S1204, and the CPU 211 displays the inspection setting screen 500 again. In a case where it is determined that the prediction value does not exceed the detection size, the process proceeds to step S1210, and the CPU 211 waits for the user to press the inspection setting complete button 505. When it is detected that the inspection setting complete button 505 is pressed, the inspection setting is confirmed, and the processing of setting the print setting and the inspection setting is ended.

Note that in the flowchart of FIG. 12, the inspection result is predicted when the setting values in the various types of setting areas are input, but the timing of predicting the inspection result is not limited to this. After both the print setting and the inspection setting of the job are set and before the job is executed, the inspection result may be predicted, and the popup 1001 of warning may be displayed depending on the prediction result. For example, the timing may be a timing when the inspection setting complete button 505 is pressed.

As described above, according to this processing, the prediction curve of the size of the precursory phenomenon is obtained from the tracking record of the precursory phenomenon of occurrence of a defect caused by the printing apparatus, and whether the defect caused by the printing apparatus occurs during printing can be determined based on the prediction curve and the number of scheduled print sheets. In a case where the defect is predicted to occur, a warning such as an instruction to change the inspection level can be issued before executing the job.

FIGS. 13A and 13B are flowcharts for describing details of the precursory phenomenon diagnostic processing (S1109) executed by the inspection apparatus 104 of the image forming system 100 according to the first embodiment. The processing shown in this flowchart is implemented by the CPU 251 of the inspection apparatus 104 executing a program deployed in the memory 252.

First, in step S1301, the CPU 251 determines whether the precursory phenomenon diagnosis state is the precursory phenomenon detection state or the precursory phenomenon tracking state, or neither of them. In a case of neither of them, the process proceeds to step S1313. In a case of the precursory phenomenon detection state or the precursory phenomenon tracking state, the process proceeds to step S1302. In step S1302, the CPU 251 determines whether it is a timing to detect or track the precursory phenomenon for the acquired inspection target image. This timing may be, for example, every time an inspection target image is generated, or may be at intervals of a predetermined number of images (e.g., 100). However, in a case where the timing is at intervals of a predetermined number, the inspection apparatus 104 counts what number the obtained inspection target image is, and determines that it is the timing when the count value exceeds the predetermined number. In a case of not the timing, the CPU 251 ends the precursory phenomenon diagnosis in the inspection target image. In a case of the timing, the process proceeds to step S1303.

In step S1303, the CPU 251 determines whether a predetermined number (e.g., 5) of inspection target images for feature extraction have been obtained after determining that it is time to detect or track the precursory phenomenon. In a case where the predetermined number has not been obtained, the precursory phenomenon diagnosis in this inspection target image is ended. On the other hand, in a case of having obtained the predetermined number of inspection target images, the process proceeds to step S1304.

In step S1304, the CPU 251 determines whether the current precursory phenomenon diagnosis state is the detection state. In a case where the detection state is determined, the process proceeds to step S1305, and in a case where the detection state is not determined, that is, the tracking state is determined, the process proceeds to step S1309.

In step S1305, the CPU 251 extracts a feature specific to the process part that is a cause of the precursory phenomenon from the inspection target image for feature extraction. Then, the process proceeds to step S1306, and the CPU 251 determines whether the inspection target image for feature extraction has a specific feature for each type of process part that is a cause of the precursory phenomenon. Here, in a case where it is determined that the inspection target image has a specific feature, that is, it is determined that the feature of the part can be extracted from the inspection target image, the process proceeds to step S1307, and the CPU 251 specifies the type of the process part that is the cause of the precursory phenomenon. Then, the process proceeds to step S1308, and the CPU 251 changes the precursory phenomenon diagnosis state to the tracking state, and ends this processing. On the other hand, in a case where it is determined in step S1306 that the feature has not been extracted, the precursory phenomenon diagnosis in this inspection target image for feature extraction is ended.

In a case where the tracking state is determined in step S1304, the process proceeds to step S1309, and the CPU 251 extracts, from the inspection target image for feature extraction, the feature specific to the process part that is the cause of the precursory phenomenon specified in step S1307. Then, the process proceeds to step S1310, and the CPU 251 measures the size of the precursory phenomenon based on the extracted feature. Then, the process proceeds to step S1311, and the CPU 251 records the measured size of the precursory phenomenon as a precursory phenomenon tracking record in association with the type of the process part of the specified cause and the accumulated number of print sheets. Then, the process proceeds to step S1312, the CPU 251 calculates a prediction curve based on the precursory phenomenon tracking record and the processing proceeds to step S1305, and the CPU 251 detects a precursory phenomenon that has not been tracked yet.

In a case where the CPU 251 determines in step S1301 that the precursory phenomenon diagnosis state is neither the precursory phenomenon detection state nor the precursory phenomenon tracking state, that is, in a case of determining the confirmation state of automatic recovery, the process proceeds to step S1313. In step S1313, the CPU 251 determines whether a predetermined number of inspection target images for feature extraction necessary for confirmation of automatic recovery have been obtained since printing of the first job after the operation of automatic recovery is started. In a case of having not obtained, the CPU 251 ends the precursory phenomenon diagnosis in the inspection target image.

On the other hand, when the CPU 251 determines that the predetermined number has been obtained in step S1313, the process proceeds to step S1314, and the CPU 251 extracts, from the inspection target image for feature extraction, the feature specific to the process part that is the cause of the precursory phenomenon specified in step S1307. Next, the process proceeds to step S1315, and the CPU 251 measures the position and size of the precursory phenomenon based on the extracted feature. Then, the process proceeds to step S1316, and the CPU 251 records the size of the precursory phenomenon measured in step S1315 as a precursory phenomenon tracking record in association with the type of the process part of the specified cause and the accumulated number of print sheets.

Next, the process proceeds to step S1317, and the CPU 251 determines whether the precursory phenomenon has been resolved based on the size of the recorded precursory phenomenon. Here, in a case where it is determined that the precursory phenomenon has been resolved, the process proceeds to the next step S1318, and in a case where it is determined that the precursory phenomenon has not been resolved, the process proceeds to step S1319, and the CPU 251 changes the precursory phenomenon diagnosis state to the state for which a countermeasure is required, and ends this precursory phenomenon diagnostic processing.

In step S1318, the CPU 251 determines whether there is a precursory phenomenon being tracked other than the precursory phenomenon confirmed in step S1317. Here, in a case where it is determined that there is a precursory phenomenon being tracked, the process proceeds to step S1321, and in order to continue tracking of the precursory phenomenon, the precursory phenomenon diagnosis state is changed to the tracking state, and this processing is ended. In a case of determining in step S1318 that there is no other precursory phenomenon being tracked, the process proceeds to step S1320, and the CPU 251 changes the precursory phenomenon diagnosis state to the detection state, and ends this precursory phenomenon diagnostic processing.

As described above, according to the first embodiment, at the time of a state where one or more types of precursory phenomena are detected, the prediction curve of the size of the future precursory phenomenon is calculated based on the recorded size of the precursory phenomenon. Then, when the print setting or the inspection setting is performed by the user, the size of the precursory phenomenon (fault) at the time of printing the set number of sheets is predicted from the prediction curve. Furthermore, it is determined whether the predicted size of precursory phenomenon exceeds the detection size of the inspection level set in the inspection setting. Then, when it is determined that the set inspection level is a level at which it is determined that the printed material whose inspection result is NG is continuously generated during the execution of the job, a warning is displayed as a popup on the display unit of the external PC. This can prevent the user from executing a job in which the job is interrupted due to continuous NG and rework occurs. Furthermore, depending on the determination result, the user can preferentially perform a job with a smaller number of print sheets or a job with a looser inspection level. Doing this can suppress the occurrence of inspection NG to continue the printing also while waiting for the arrival of the service person who has been requested to resolve the precursory phenomenon that will cause an inspection NG in the future.

Although the first embodiment has been described above, the present disclosure is not limited to the first embodiment described above. For example, the inspection apparatus 104 includes the inspection module 321 and the precursory phenomenon diagnostic module 322, but these modules may be included in the server 102. That is, the server 102 may perform the inspection processing including processing of comparing the inspection target image with the reference image and the precursory phenomenon diagnostic processing. The server 102 may include a GPU as hardware to perform image comparison processing at high speed.

Specifically, the inspection target image read and generated by the reading unit 255 of the inspection apparatus 104 is sent to the server 102. Then, the inspection module 321 of the server 102 compares the reference image generated by the server 102 with the inspection target image obtained from the inspection apparatus 104 to determine presence or absence of a defect of the printed material. Based on the inspection target image generated by the inspection apparatus 104, the precursory phenomenon diagnostic module 322 of the server 102 may perform detection of the precursory phenomenon, tracking of the precursory phenomenon, and automatic recovery for resolving the precursory phenomenon.

### Second Embodiment

In the second embodiment, a case where the change amount of the size of the precursory phenomenon changes depending on the image to be printed will be described. Note that since the configuration, hardware configuration, and the like of the image forming system according to the second embodiment are common to those of the first embodiment, the description thereof will be omitted.

Causes of changing the change amount of the size of the precursory phenomenon include a toner use amount, for example. For example, in a case of a precursory phenomenon that increases due to the toner adhering to damage or a foreign matter on the photosensitive drum, the increase amount of the size of the precursory phenomenon also increases as the toner use amount increases. Therefore, a more accurate prediction curve can be obtained if the increase amount of the prediction curve is changed in accordance with the toner use amount at the time of printing the image data.

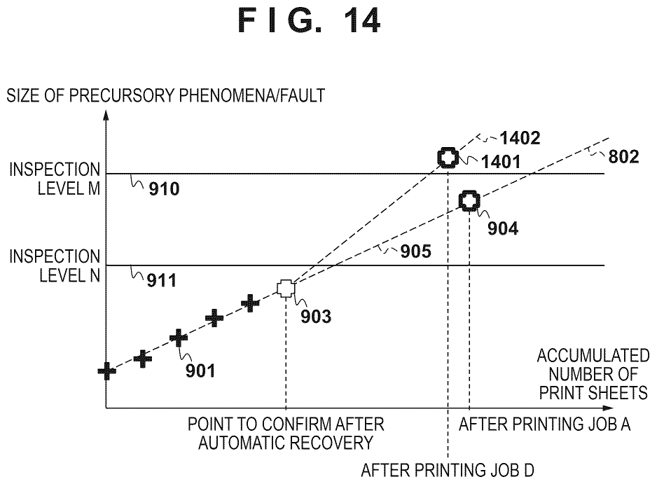

FIG. 14 depicts a view for describing the operation of the inspection result prediction module 313 of the external PC 101 according to the second embodiment. Since FIG. 12 is a modification of FIG. 9 of the first embodiment, portions common to FIG. 9 are given the same reference numerals, and the description thereof will be omitted.

A precursory phenomenon 1401 after printing of a job D indicates a prediction value of the size of the precursory phenomenon in a case assuming that printing is performed only for a set print copies in the job D for which print setting different from that of the job A is performed. Here, it is assumed that the number of print sheets of the job D is smaller than that of the job A. Furthermore, it is assumed that the image data of the job D has a larger toner use amount than that of the job A. The image data having a large toner use amount is, for example, original image data including a large number of pages having a high density, or image data generated when the toner density is set high in print setting. A prediction curve 1402 is a prediction curve calculated to obtain the precursory phenomenon 1401 after printing of the job D. It is assumed that the toner use amount of the image data of the job having been executed at the time point when the tracking point 901 used to calculate the prediction curve 802 is recorded is the same as that of the job A. The prediction curve 1402 has a slope larger than that of the prediction curve 802 calculated using the tracking point 901. Therefore, as in FIG. 14, although the number of print sheets of the job D is smaller than that of the job A, the predicted size of the precursory phenomenon may be larger than that of the job A.

As a method of obtaining the prediction curve 1402, first, the prediction curve 802 is calculated using the tracking point 901. Here, a primary straight line is obtained by linear regression. Next, the slope of the primary straight line is adjusted depending on the toner use amount of the job D. This adjustment amount is obtained based on the ratio of the average of the toner use amount of the job D to the average of the toner use amount of each page of the image data of the job executed immediately before. For example, in a case where the toner use amount is doubled, the slope of the primary straight line is adjusted to be doubled. The toner use amount of the immediately preceding job is obtained from a job history recorded in an application of the external PC 101, for example.

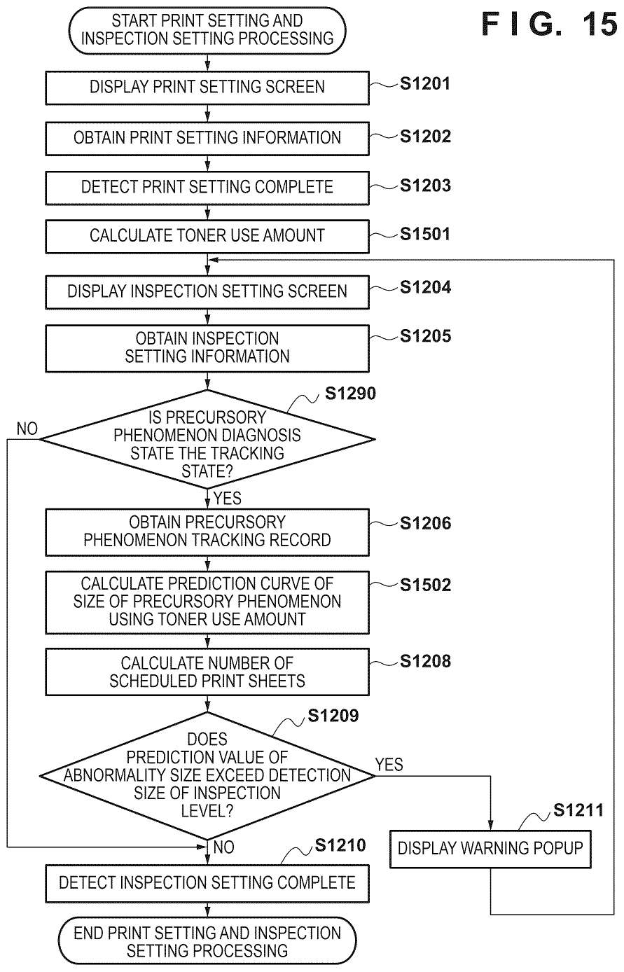

FIG. 15 is a flowchart for describing the processing of the print setting and the inspection setting (S1101) to be executed by the external PC 101 in the image forming system 100 according to the second embodiment. This flowchart is a modification of the flowchart of FIG. 12 according to the first embodiment, and processing common to that in FIG. 12 is denoted by the same reference numeral, and the description thereof will be omitted. Note that the processing shown in this flowchart is implemented by the CPU 211 of the external PC 101 executing a program deployed in the memory 212. The processing described in this flowchart is started by pressing the new job creation button not illustrated in an application executed by the external PC 101, for example.

When the print setting is completed in step S1203, the process proceeds to step S1501, and the CPU 211 calculates the toner use amount of the job and the immediately preceding job based on the print setting set by the user on the print setting screen 400. The toner use amount of the immediately preceding job can be obtained from a job history recorded in an application of the external PC 101, for example. This step S1501 is executed when it is detected in step S1203 that the print setting complete button 403 has been pressed. When step S1501 is performed, the process proceeds to step S1204.

Then, when the CPU 211 obtains the tracking record of the precursory phenomenon in step S1206, the process proceeds to step S1502, and the CPU 211 calculates the prediction curve 1402 of the size of the precursory phenomenon from the tracking record of the precursory phenomenon, the toner use amount of the immediately preceding job, and the toner use amount obtained in step S1501. The subsequent processing is similar to that of the first embodiment described above.

According to the second embodiment, a more accurate prediction curve can be obtained by changing the increase amount of the prediction curve in accordance with the toner use amount at the time of printing the image data. This can suppress a job from being interrupted due to continuous NG even if a warning is not issued when image data with a high toner use amount is printed.

In the prediction curve obtained from the number of print sheets and the size of the precursory phenomenon, there is a possibility of execution without warning by adopting a prediction curve corresponding to the toner use amount even for a job with a small toner use amount that was predicted to be interrupted halfway during the execution of the job due to continuous NG.

### Third Embodiment

In the third embodiment, an operation in a case where a precursory phenomenon is not resolved by automatic recovery in a state where a plurality of already set jobs are accumulated in the print job queue will be described. Note that since the configuration, hardware configuration, and the like of the image forming system according to the third embodiment are common to those of the first embodiment, the description thereof will be omitted.

The print job queue holds a job for which print setting and inspection setting have been made until printing is completed. The print job queue is implemented by holding job data in the memory 212 or the auxiliary storage 213 of the external PC 101 until transmission to the server 102 after completion of the print setting and the inspection setting of the job on the external PC 101, for example. Alternatively, the job data transmitted to the server 102 may be implemented by holding the job data in the memory 222 or the auxiliary storage 223 of the server 102 until printing and inspection of all pages are completed.

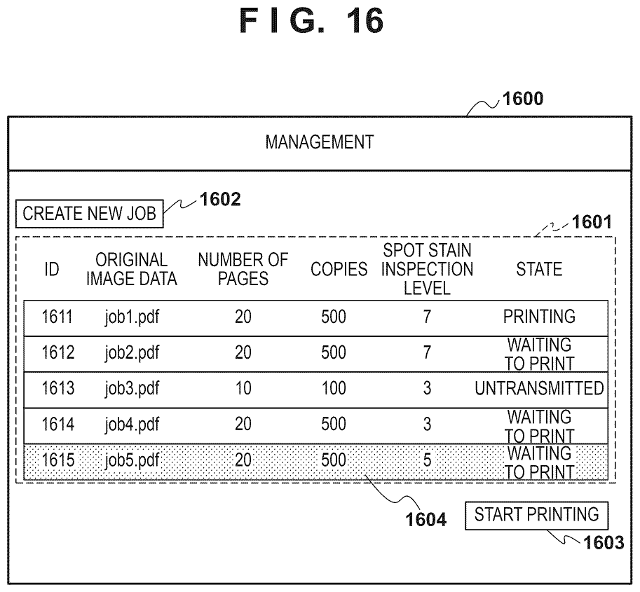

FIG. 16 depicts a view illustrating an example of a job management screen that displays jobs held in the print job queue in the third embodiment.

A job management screen 1600 includes a job list 1601 held in a queue, a new job creation button 1602, and a print start button 1603. When the new job creation button 1602 is pressed, the screen sequentially transitions to the print setting screen 400 and the inspection setting screen 500 described above, and the print setting and the inspection setting are performed. When these settings are completed and the screen returns to the job management screen 1600, the job created at that time is added to the final position of the job list 1601. Also in a case where the setting is not completed to the end and the screen returns to the job management screen 1600, a job for which setting is uncompleted may be added to the job list 1601. The job list 1601 includes an ID for identifying the job, an original image data name, the number of pages of the original image data, print copies designated in the print setting, an inspection level of spot stain designated in the inspection setting, and a job status, but the information to be displayed is not limited to this. For example, the number of pages needs not be displayed, and the inspection level of streak stain may be displayed. When the print start button 1603 is pressed in a state where a job is clicked and selected as in a job 1604, for example, data of the selected job is transmitted to the server 102, and execution start of the job is instructed to the server 102.

In the job list 1601, regarding the job state, a job for which printing is being executed by the printing apparatus 103, for example, is displayed as printing, and a job waiting for print completion of the immediately preceding job by pressing the print start button 1603 is displayed as waiting to print. A job for which the print start button 1603 is not pressed is displayed as untransmitted. The job waiting to print is sequentially switched during printing as soon as the job in printing of the preceding job is completed, and printing and inspection are started.

Note that on the job management screen 1600 in FIG. 16, the inspection level for the defect of the detection target, for example, spot stain, streaks, or the like, which is predicted to result in NG as a result of inspection, may be displayed in the job list 1601.

In the job list 1601, by displaying, at a high level in the job list 1601, a job with a low inspection level, that is, a job in which inspection NG is less likely to occur, the user may be urged to preferentially execute a job in which inspection NG is less likely to occur.

In the third embodiment, processing of a job waiting to print in a case where the precursory phenomenon is not resolved by automatic recovery in a state where a plurality of already set jobs are accumulated in the print job queue will be described. According to the third embodiment, the state of the job waiting to print is changed depending on the prediction of the inspection result prediction module 313. This can prevent execution of a job in which the job is interrupted halfway due to continuous NG and rework occurs.

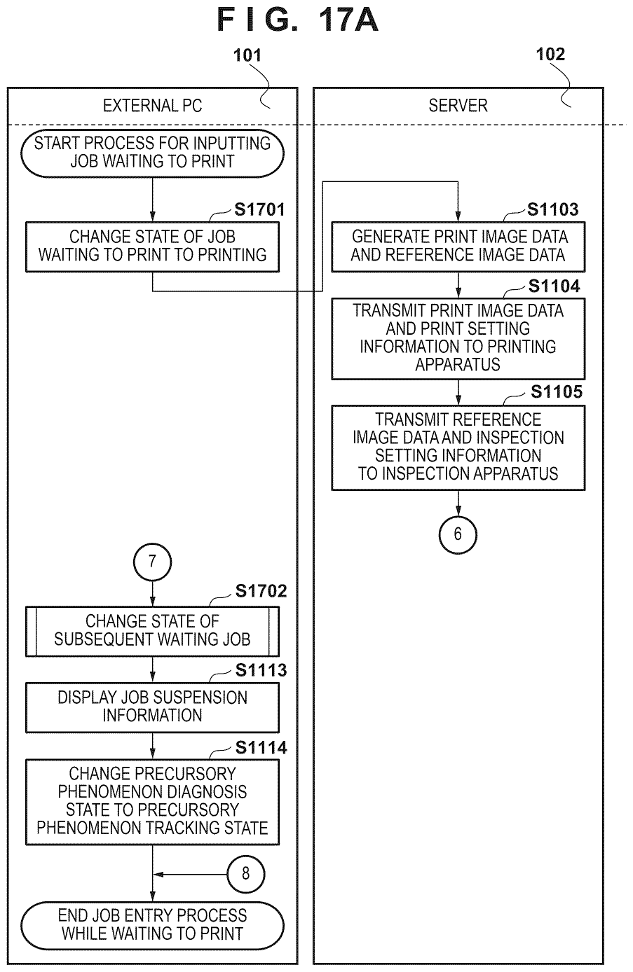

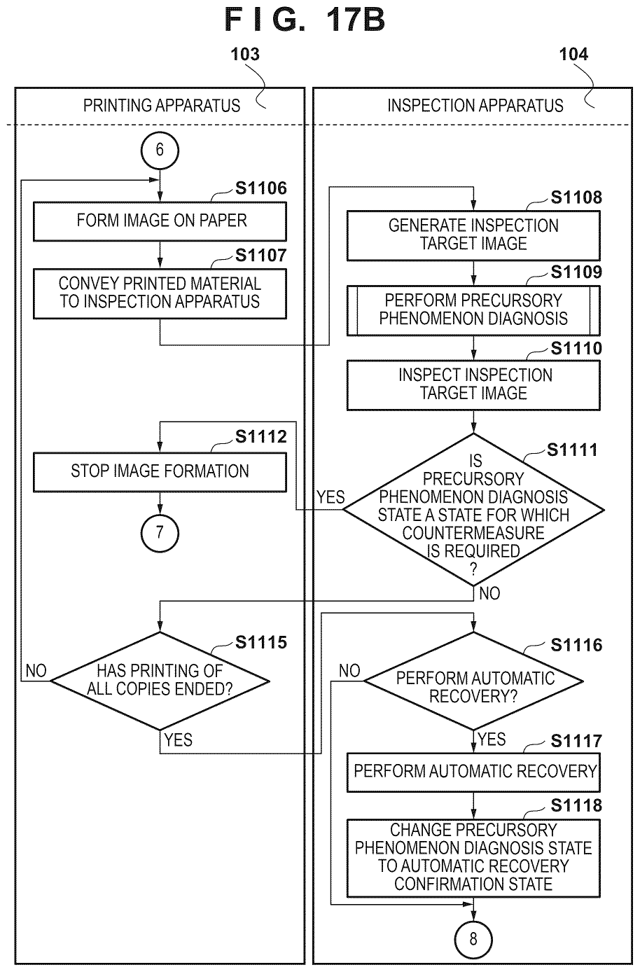

FIGS. 17A and 17B are sequence diagrams describing from setting of a job to be executed by the image forming system 100 according to the third embodiment to print completion. This sequence is started when a program of an application necessary for operating the system is activated in the external PC 101. FIGS. 17A and 17B illustrate a modification example of FIGS. 11A and 11B, and the process thereof is started in a case where there is a job waiting for printing in a subsequent job when one job being printed is completed. Note that processing common to that in FIGS. 11A and 11B described above is denoted by the same reference numeral, and the description thereof will be omitted.

In step S1701, the CPU 211 of the external PC 101 changes the state of the job waiting to print to printing, and starts printing.

When the image formation by the printing apparatus 103 is stopped in step S1112, the process proceeds to step S1702, and the CPU 211 of the external PC 101 changes the state of the subsequent job waiting to print in accordance with the prediction of the inspection result prediction module 313. This processing in step S1702 is executed after the inspection apparatus 104 determines in step S1111 that the precursory phenomenon diagnosis state is a state for which a countermeasure is required and the printing apparatus 103 stops in step S1112 the image formation.

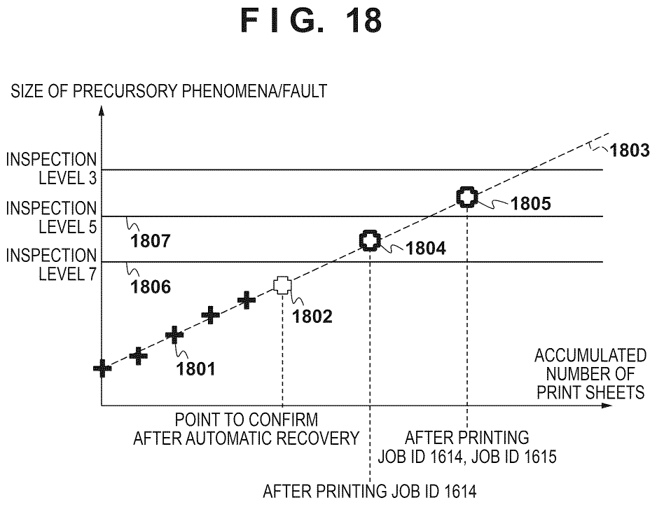

FIG. 18 depicts a view for describing the operation of the inspection result prediction module 313 according to the third example. Here, processing of changing the state of the job waiting to print in accordance with the prediction of the inspection result prediction module 313 in step S1702 in FIG. 17A will be described with reference to FIGS. 16 and 18.

In FIG. 18, a tracking point 1801 indicates the recorded size of the precursory phenomenon tracked at the time of the accumulated number of print sheets. A precursory phenomenon 1802 after automatic recovery indicates the size of the precursory phenomenon after the automatic recovery is performed after the job of a job ID “1611” in the job list 1601 in FIG. 16 is completed, and here, it indicates that the precursory phenomenon has not been resolved by the automatic recovery. A dashed line 1803 is a prediction curve calculated from the tracking point 1801. Both the job of a job ID “1612” and the job of a job ID “1614” have the same number of print sheets. In a case where any of the job of the job ID “1612” and the job of the job ID “1614” is executed after the automatic recovery of the job of the job ID “1611” is confirmed, the precursory phenomenon is enlarged to the size indicated by a precursory phenomenon 1804 in any case. Since the inspection level of the job of the job ID “1612” is 7, and the size of the precursory phenomenon after the enlargement is larger than a detected minimum size 1806 of the inspection level 7, continuous NG is highly likely to occur. Therefore, after the automatic recovery is confirmed, it is desirable to prioritize the job of the job ID “1614” (inspection level 3). Therefore, the state of the job of the job ID “1612” is changed to a waiting for recovery state so as not to be executed until repair or the like by the service person is performed.

Furthermore, in step S1702, a job to be executed after printing of the job of the job ID “1614” is completed is also selected. When it is determined whether to execute the job of a job ID “1615”, the size of the precursory phenomenon when the number of print sheets of the job of the job ID “1615” is further printed from the accumulated number of print sheets after printing the job of the job ID “1614” is predicted from the prediction curve 1803. A precursory phenomenon 1805 indicates the size of the precursory phenomenon when the job of the job ID “1615” is printed after the job of the job ID “1614” is printed. Here, since the inspection level of the job of the job ID “1615” is 5, the size of the precursory phenomenon 1805 is larger than a detected minimum size 1807 of the inspection level 5. Therefore, the state of the job of the job ID “1615” is changed to a waiting for recovery state.

Thus, in a case where a plurality of already set jobs are accumulated in the print job queue, the job to be executed next can be determined based on the print setting and the inspection setting of the job and the prediction curve of the precursory phenomenon.

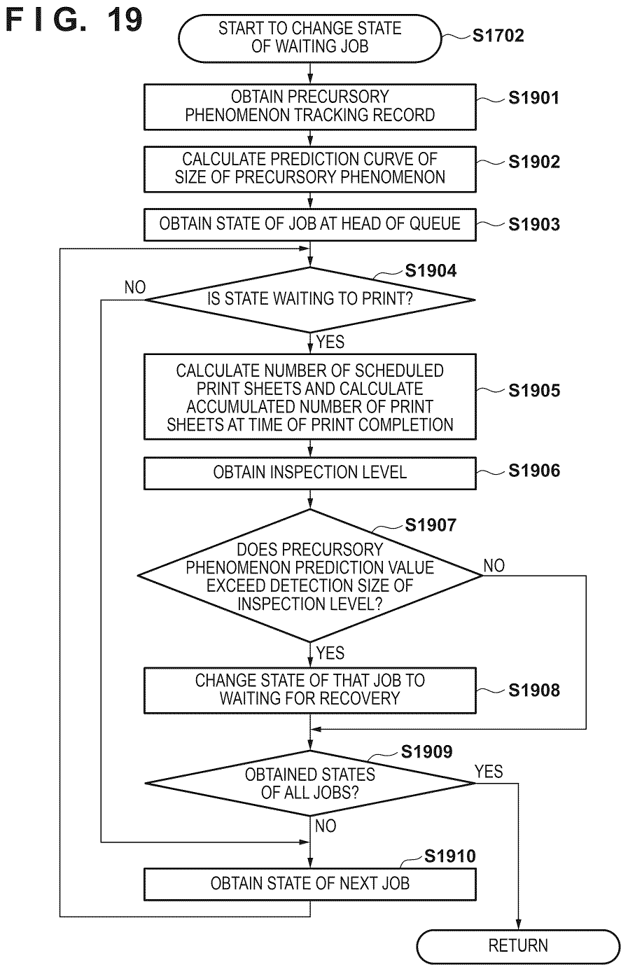

FIG. 19 is a flowchart for describing details of state change processing (step S1702) of the job on waiting to be executed by the external PC 101 of the image forming system 100 according to the third embodiment. Note that the processing shown in this flowchart is implemented by the CPU 211 of the external PC 101 executing a program deployed in the memory 212.

First, in step S1901, the CPU 211 obtains a tracking record of the precursory phenomenon. Next, the process proceeds to step S1902, and the CPU 211 calculates a prediction curve of the size of the precursory phenomenon from the tracking record of the precursory phenomenon. Next, the process proceeds to step S1903, and the CPU 211 obtains the state of the top job in the print job queue. Then, the process proceeds to step S1904, and the CPU 211 determines whether the obtained state of the job is waiting to print. Here, when it is determined to be not to be waiting to print, the process proceeds to step S1910, and when it is determined to be waiting to print, the process proceeds to step S1905.

In step S1905, the CPU 211 calculates the number of scheduled print sheets from the print setting information of the job. Furthermore, in a case where there is a job whose state is waiting to print before the job, the accumulated number of print sheets at the time of print completion of the job is calculated by adding the number of scheduled print sheets. Next, the process proceeds to step S1906, and the CPU 211 obtains the inspection level from the inspection setting information of the job. Then, the process proceeds to step S1907, and the CPU 211 determines whether the prediction value of the size of the precursory phenomenon at the time of print completion exceeds the detection size of the inspection level set in the inspection setting, using the number of scheduled print sheets and the predicted curve. In a case where it is determined that the prediction value exceeds the detection size, the process proceeds to step S1908, and the CPU 211 changes the state of the job to waiting for recovery and the process proceeds to step S1909. On the other hand, in a case where it is determined in step S1907 that the prediction value does not exceed the detection size, the process proceeds to step S1909 while the state of the job is kept as waiting to print. In step S1909, the CPU 211 determines whether the states of all the jobs existing in the queue have been obtained. In a case where it is determined that the states have not been obtained, the process proceeds to step S1910, the state of the next job of the job is obtained, and the process proceeds to step S1904. When the states of all the jobs existing in the queue are obtained in this manner, the state change processing of this job on waiting is ended.

As described above, according to the third embodiment, in a case where the precursory phenomenon is not resolved by the automatic recovery in a state where a plurality of already set jobs are accumulated in the print job queue, the state of the subsequent job waiting to print is changed in accordance with the prediction of the inspection result prediction module. This can prevent execution of a job in which the job is interrupted due to continuous NG and rework occurs. Furthermore, by preferentially performing a job with a smaller number of print sheets or a job with a looser inspection level, printing can be continued also while waiting for the arrival of the service person.

### Other Embodiments

Embodiments of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims priority to Japanese Patent Application No. 2024-219007, which was filed on Dec. 13, 2024, and which is hereby incorporated by reference herein in its entirety.

What is claimed is:

1. An image forming system comprising a printing apparatus, an inspection apparatus that inspects a printed material printed by the printing apparatus and an information processing apparatus that controls the printing apparatus and the inspection apparatus,
wherein the information processing apparatus includes
one or more first controllers including one or more first processors in communication with one or more first memories, the one or more first controllers configured to:
perform print setting of a job for causing the printing apparatus to execute printing; and
perform inspection setting for inspection in the inspection apparatus on the job,
wherein the inspection apparatus includes
one or more second controllers including one or more second processors in communication with one or more second memories, the one or more second controllers configured to:
read a printed material printed by the printing apparatus in accordance with the job to generate a read image; and
detect a precursory phenomenon that can be a defect of the printed material included in the read image,
wherein the one or more first controllers further configured to:
predict whether the defect occurs when printing is performed in accordance with the print setting and the inspection setting, based on the print setting, the inspection setting and the detected precursory phenomenon; and
notify in a case where an occurrence of the defect is predicted,
wherein the inspection setting includes an inspection threshold for determining whether the precursory phenomenon corresponds to a defect of the printed material.

2. The image forming system according to claim 1, wherein the precursory phenomenon is a fault to be detected by comparison between the read image and a reference image, and corresponds to a fault in which a shape and a position of the fault are common.

3. The image forming system according to claim 1, wherein the inspection threshold corresponds to a minimum size of a defect of a detection target that is able to be detected by the inspection apparatus.

4. The image forming system according to claim 1, wherein in the notifying, the one or more first controllers notify that the defect is predicted to occur when printing is performed in the print setting and the inspection setting.

5. The image forming system according to claim 4, wherein in the notifying, the one or more first controllers further perform notification including an inspection threshold when the defect is predicted to occur.

6. The image forming system according to claim 1, wherein the print setting that is set includes at least image data of an original and print copies.

7. The image forming system according to claim 1, wherein in the detecting the precursory phenomenon, the one or more second controllers specify a component of the printing apparatus that is a cause of the precursory phenomenon when detecting the precursory phenomenon.

8. The image forming system according to claim 1, wherein in the detecting the precursory phenomenon, the one or more second controllers record a size of a fault corresponding to the precursory phenomenon in association with a number of read images of a printed material printed by the printing apparatus after detecting the precursory phenomenon.

9. The image forming system according to claim 8, wherein in the detecting the precursory phenomenon, the one or more second controllers obtain a prediction curve for predicting the size of the precursory phenomenon with respect to a number of print sheets to be printed by the printing apparatus based on the number of the read images and the size of the fault corresponding to the precursory phenomenon.

10. The image forming system according to claim 1, wherein the one or more second controllers further configured to:
instruct the printing apparatus to perform automatic recovery for resolving the precursory phenomenon after the job is completed in a case that one or more types of precursory phenomena are in a detected state.

11. The image forming system according to claim 9, wherein the one or more second controllers further configured to:
instruct the printing apparatus to perform automatic recovery for resolving the precursory phenomenon in a case where the prediction curve when a predetermined number of sheets are further printed by the printing apparatus exceeds the inspection threshold after the job is completed in a case that one or more types of precursory phenomena are in a detected state.

12. The image forming system according to claim 9, wherein in the prediction, the one or more second controllers predict that a defect occurs when performing printing with the print setting in a case where the prediction curve when printing a set number of sheets exceeds the inspection threshold that is set, in a case that one or more types of precursory phenomena are in a detected state.

13. The image forming system according to claim 1, wherein in the inspection setting, the one or more first controllers further disable setting of an option of an inspection threshold of the inspection setting in which the defect is predicted to occur in a case that one or more types of precursory phenomena are in a detected state.

14. The image forming system according to claim 12, wherein the one or more first controllers further configured to:
obtain a toner use amount to be used in the job based on the print setting,
wherein in the prediction, the one or more second controllers predict whether the defect occurs by changing the prediction curve based on the toner use amount.

15. The image forming system according to claim 14, wherein the one or more first controllers further configured to:
record the toner use amount in a job history, and when changing an increase amount of the prediction curve, refer to the toner use amount recorded in the job history.

16. The image forming system according to claim 9, wherein the one or more first controllers further configured to:
hold one or more jobs having the print setting that is set and the inspection setting that is set; and
sequentially execute the jobs that are held.

17. The image forming system according to claim 16, wherein in the prediction, the one or more second controllers predict that a defect occurs when performing printing with the print setting in a case where the prediction curve when printing a set number of sheets exceeds the inspection threshold that is set in each of a plurality of jobs held in the holding in a case that one or more types of precursory phenomena are in a detected state, and prevent a job for which the defect is predicted to occur from being executed.

18. An information processing apparatus that controls a printing apparatus and an inspection apparatus that inspects a printed material printed by the printing apparatus, the information processing apparatus comprising:
one or more controllers including one or more processors in communication with one or more memories, the one or more controllers configured to:
perform print setting of a job for causing the printing apparatus to execute printing;
perform inspection setting for inspection in the inspection apparatus on the job;
predict whether a defect occurs when printing is performed in accordance with the print setting and the inspection setting, based on the print setting, the inspection setting and a precursory phenomenon that can be a defect of the printed material included in a read image obtained by reading the printed material by the inspection apparatus; and
notify in a case where an occurrence of the defect is predicted,
wherein the inspection setting includes an inspection threshold for determining whether the precursory phenomenon corresponds to a defect of the printed material.

19. The information processing apparatus according to claim 18, wherein the precursory phenomenon is a fault to be detected by comparison between a read image of the printed material and a reference image by the inspection apparatus, and corresponds to a fault in which a shape and a position of the fault are common.

20. A method of controlling of controlling an information processing apparatus that controls a printing apparatus and an inspection apparatus that inspects a printed material printed by the printing apparatus, the method of controlling comprising:
performing print setting of a job of causing the printing apparatus to execute printing;
performing inspection setting for inspection in the inspection apparatus on the job;
predicting whether the defect occurs when printing is performed in accordance with the print setting and the inspection setting, based on the print setting the inspection setting a precursory phenomenon that can be a defect of the printed material included in a read image obtained by reading the printed material by the inspection apparatus; and
notifying in a case where an occurrence of the defect is predicted in the predicting,
wherein the inspection setting includes an inspection threshold for determining whether the precursory phenomenon corresponds to a defect of the printed material.
